(19) United States
(12) Patent Application Publication
(10) Pub. No.: US 2025/0117128 A1
(43) Pub. Date: Apr. 10, 2025

(54) AUTOMATIC CURATION OF RELEVANT CONTENT FROM DIGITAL CONTENT

(71) Applicant: WEAVE LABS, INC., SAMMAMISH, WA (US)

(72) Inventor: NOSAKHARE DANIEL OMOIGUI, SAMMAMISH, WA (US)

(73) Assignee: WEAVE LABS, INC., SAMMAMISH, WA (US)

(21) Appl. No.: 18/730,090

(22) PCT Filed: Jan. 23, 2023
(86) PCT No.: PCT/US2023/011329

§ 371 Date: Jul. 18, 2024

Related U.S. Application Data
(60) Provisional application No. 63/301,995, filed on Jan. 21, 2022.

(51) Int. Cl. G06F 3/0486; G06Q 10/10

(52) U.S. Cl. CPC G06F 3/0486; G06Q 10/103

(57) ABSTRACT

A computer-implemented method includes generating to a display device a graphical user interface (GUI), the display device being coupled to at least one processing device. A file-icon reception field is generated within the GUI. A command to move into the reception field an icon representing a digital text file containing a data set is received from a user. The digital file is accessed. A table of contents characterizing the data set is generated, one or more portions of the data set based on the table of contents are displayed in the GUI.

### PRIORITY CLAIM

This application claims priority from U.S. Prov. Pat. Appl. No. 63/301,995 filed Jan. 21, 2022, the entirety of which is hereby incorporated by reference as if fully set forth herein.

### COPYRIGHT NOTICE

This disclosure is protected under United States and/or International Copyright Laws. © 2023 Weave Labs, Inc., All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### BACKGROUND

Information is the lifeblood of modern business. Yet businesses are facing an unprecedented information crisis: a whopping 19.8 percent of business time—the equivalent of one day per working week—is wasted by employees searching for information to do their job effectively (Interact, Mckinsey). According to Forbes it will take the average information worker two hours to read or prioritize all the information he or she receives daily—from long-form blog posts to news articles and newsletters to research reports to emails, Tweets and LinkedIn notifications. And yet the pile keeps growing—with the volume of digital information doubling every 18 months (Kleiner Perkins).

This creates a dilemma for information workers: keeping up with industry trends is increasingly mission-critical especially in a fast-changing business and technology landscape. This is further exacerbated in highly regulated industries (e.g., financial services, healthcare, Tech, and other industries that have subject to cybersecurity and privacy regulations) where the lack of efficient information access—essential for compliance—can lead to mortal business risk. Yet users get frustrated when they try to engage with information using existing paradigms. Users often don't know what they don't know so they don't know what to search for in the first place. This is particularly acute in new and fast-evolving domains. Cybersecurity professionals don't know which threats to search for because new threats are discovered at a startling rate—in other words, oftentimes they don't know what they don't know. Financial research professionals might not know the precise context to search for a given investment opportunity—as said context might be buried deep in financial reports. Secondly the volume of information is increasing tenfold every five years and distilling the massive heap of information into the most critical insights has become harder than ever.

The problem keeps getting worse. We live in a world where advertising, not business productivity fuel the dissemination of information. We rely on search engines, typically Google, and social media, as the core paradigms. The search ecosystem monetizes each search attempt, not productivity or the delivery of insight. Indeed, paradoxically, today's search and media engines (including social media) profit from a loss of productivity—via more searches, more video views within a filter bubble, etc.

Business decisions—be they in sales, marketing, finance, investments, M&A, business strategy, etc.—are made at the subject area level, not keywords. Context matters and keywords and lists of blue hyperlinks neither understand nor convey context.

Lastly, information is more fragmented than ever before: on numerous sources and in many formats—from podcasts to webinars, to industry news, to industry videos, to video interviews with thought leaders, to videos of keynote presentations, to book launch presentations, to video seminars from think tanks, to relevant government and regulatory information, to social media, to highly insightful blog posts, and much more.

These problems, when combined, create an intractable problem for end users. Sales professionals need efficient access to industry information to engage with prospects, shorten sales cycles and close more deals. New sales reps need to be able to ramp very quickly to drive revenue growth especially in the current environment with near full employment (for which many new sales reps are recruited with very diverse industry backgrounds). Marketing professionals need access to information while researching new markets or writing whitepapers. HR executives are eager to effectively onboard, train and retain employees in an era of extremely high competition for talent and spiraling recruiting costs. Executives need the equivalent of the US President's ‘President's Daily Brief’ (PDB)—that distills the mountains of intelligence field reports into an intelligently summarized and contextualized report of what most requires their precious attention.

### DRAWING FIGURES

FIG. 1 is a schematic view of an exemplary operating environment in which an embodiment of the invention can be implemented;

FIG. 2 is a functional block diagram of an exemplary operating environment in which an embodiment of the invention can be implemented; and

FIGS. 3-7 are screenshots illustrating the manner in which an embodiment of the invention can be implemented.

### DETAILED DESCRIPTION

Embodiments of the present invention may comprise or utilize a special-purpose or general-purpose computer including computer hardware, such as, for example, one or more processors and system memory, as discussed in greater detail below. Embodiments within the scope of the present invention also include physical and other computer-readable media for carrying or storing computer-executable instructions or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special-purpose computer system. Computer-readable media that store computer-executable instructions are non-transitory computer-readable storage media (devices). Computer-readable media that carry computer-executable instructions are transmission media. Thus, by way of example, and not limitation, embodiments of the invention can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special-purpose computer.

A “network” is defined as one or more data links that enable the transport of electronic data between computer systems or modules or other electronic devices. When information is transferred or provided over a network or another communications connection (either hardwired, wireless, or a combination of hardwired or wireless) to a computer, the computer properly views the connection as a transmission medium. Transmissions media can include a network or data links which can be used to carry desired program code means in the form of computer-executable instructions or data structures and which can be accessed by a general purpose or special-purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special-purpose computer, or special-purpose processing device to perform a certain function or group of functions. In some embodiments, computer-executable instructions are executed on a general-purpose computer to turn the general-purpose computer into a special-purpose computer implementing elements of the invention. The computer executable instructions may be, for example, binaries, intermediate format instructions such as assembly language, or even source code.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

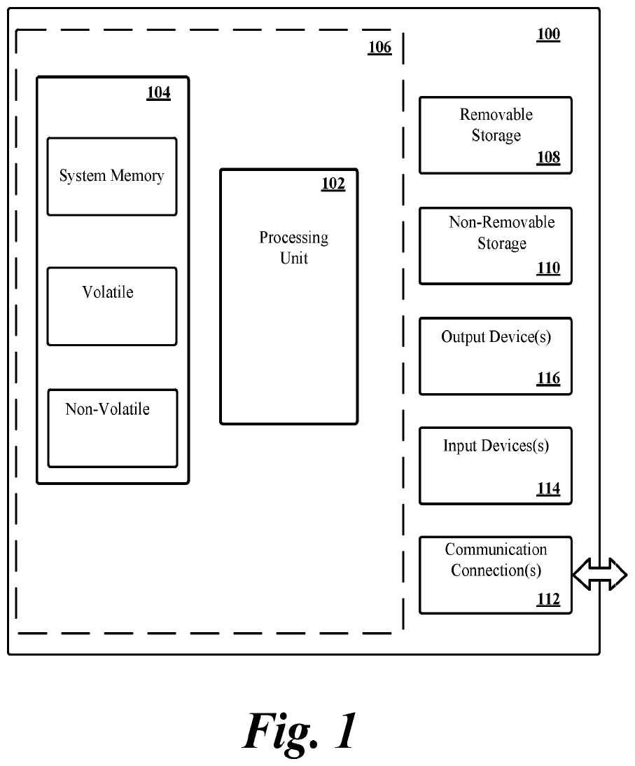

With reference to FIG. 1, an exemplary system for implementing an embodiment of the invention includes a computing device, such as computing device 100, which, in an embodiment, is or includes a smartphone. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared, cellular and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

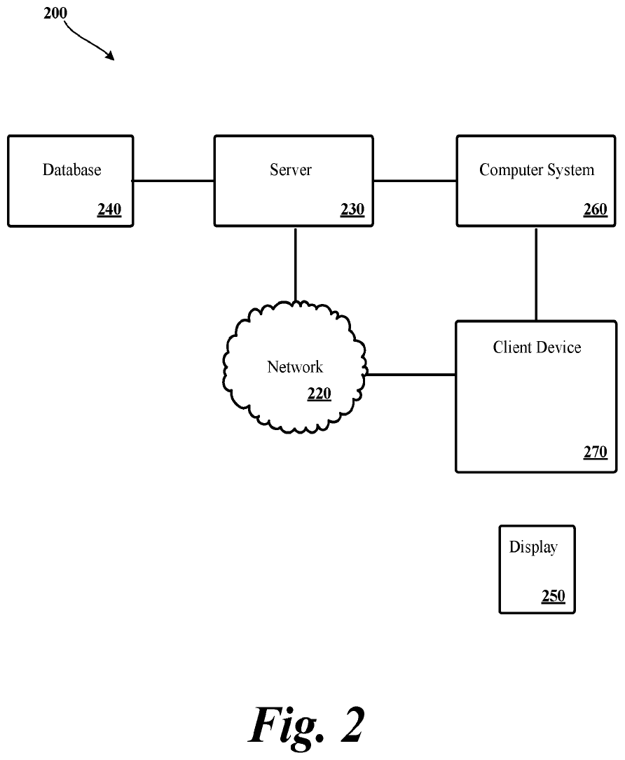

Referring now to FIG. 2, one or more embodiments of the present invention may take the form, and/or may be implemented using one or more elements, of an exemplary computer network system 200 that, in an embodiment, includes a server 230, database 240 and computer system 260. The system 200 may communicate with an electronic client device 270, such as a personal computer or workstation, tablet or smartphone, that is linked via a communication medium, such as a network 220 (e.g., the Internet), to one or more electronic devices or systems, such as server 230. The server 230 may further be coupled, or otherwise have access, to a database 240 and a computer system 260. Although the embodiment illustrated in FIG. 2 includes one server 230 coupled to one client device 270 via the network 220, it should be recognized that embodiments of the invention may be implemented using one or more such client devices coupled to one or more such servers.

The client device 270 and the server 230 may include all or fewer than all of the features associated with the device 100 illustrated in and discussed with reference to FIG. 1. The client device 270 includes or is otherwise coupled to a computer screen or display 250. The client device 270 may be used for various purposes such as network- and local-computing processes.

The client device 270 is linked via the network 220 to server 230 so that computer programs running on the client device 270 can cooperate in two-way communication with server 230. The server 230 may be coupled to database 240 to retrieve information therefrom and to store information thereto. Database 240 may have stored therein data (not shown) that can be used by the server 230 and/or client device 270 to enable performance of various aspects of embodiments of the invention. Additionally, the server 230 may be coupled to the computer system 260 in a manner allowing the server to delegate certain processing functions to the computer system. In one or more embodiments, most or all of the functionality described herein may be implemented in a desktop or smartphone application that may include one or more executable modules. In an embodiment, the client device 270 may bypass network 220 and communicate directly with computer system 260.

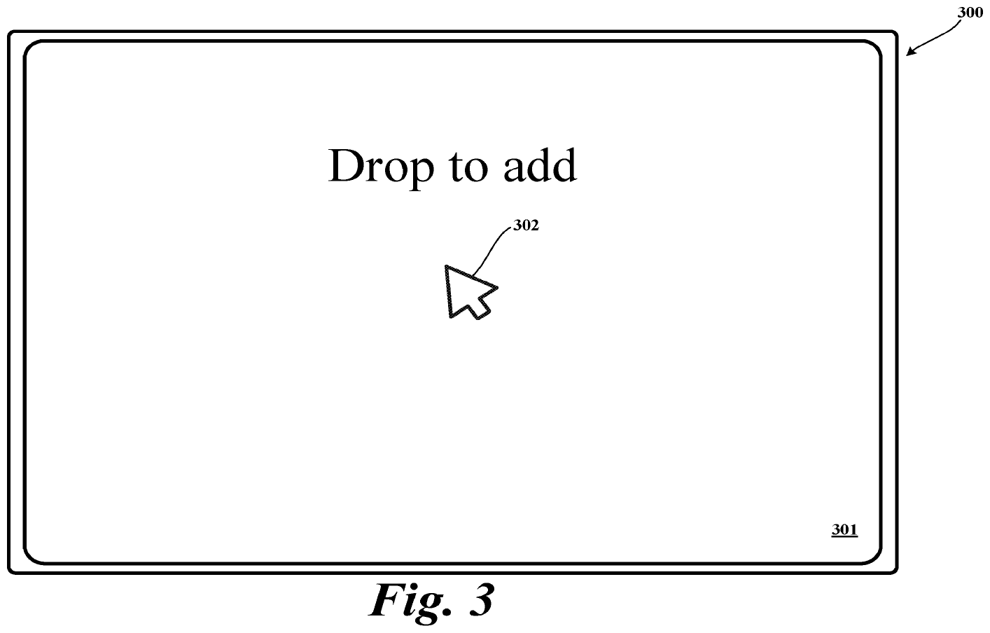

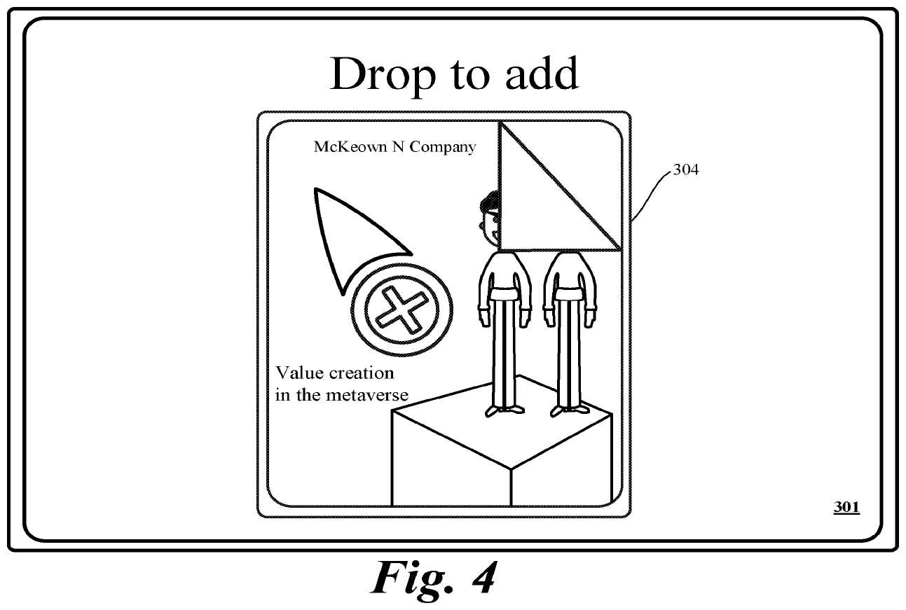

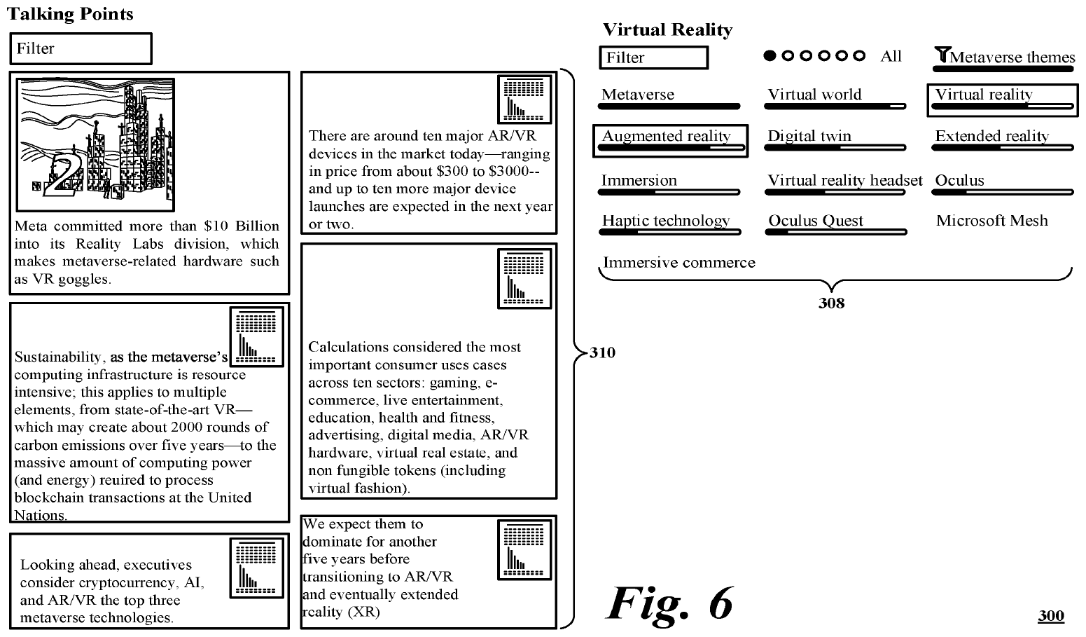

One or more embodiments discussed below herein provide a computer-implemented method, elements of which are illustrated in FIGS. 3-7. The method includes generating to a display device, such as display 250, a graphical user interface (GUI) 300. A file-icon reception field 301 is generated within the GUI 300. A command is received from a user to move into the reception field 301 an icon 304 representing a digital file containing a data set, such as a .pdf document or word processing documents of varying formats. Such data set may include text and/or graphical elements. In an embodiment, the user command can consist of the user dragging and dropping the icon 304 from another area of display 250 within the field 301 using a conventional pointer device 302.

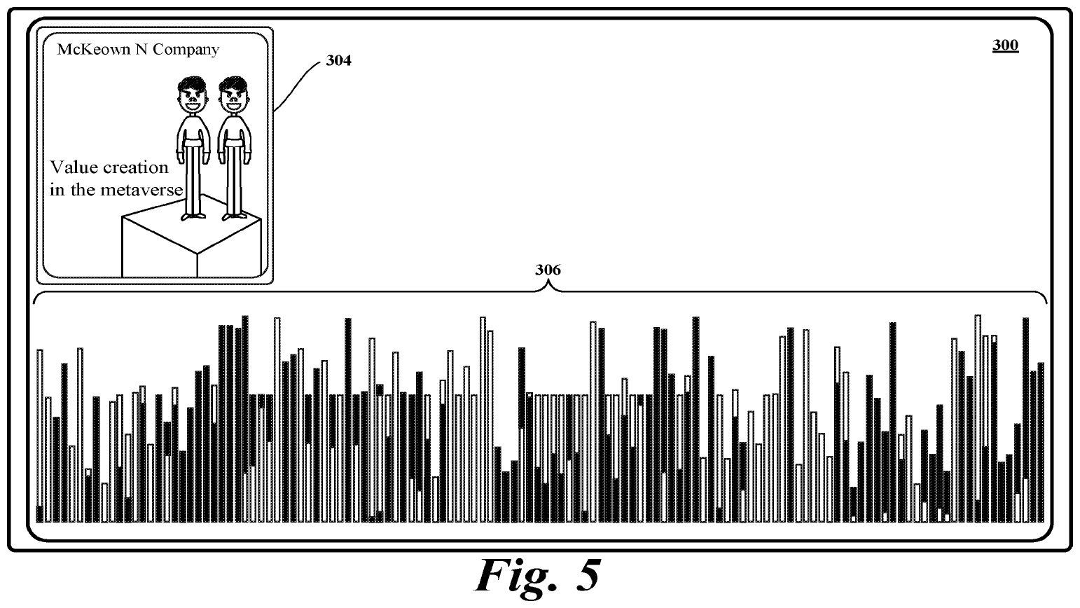

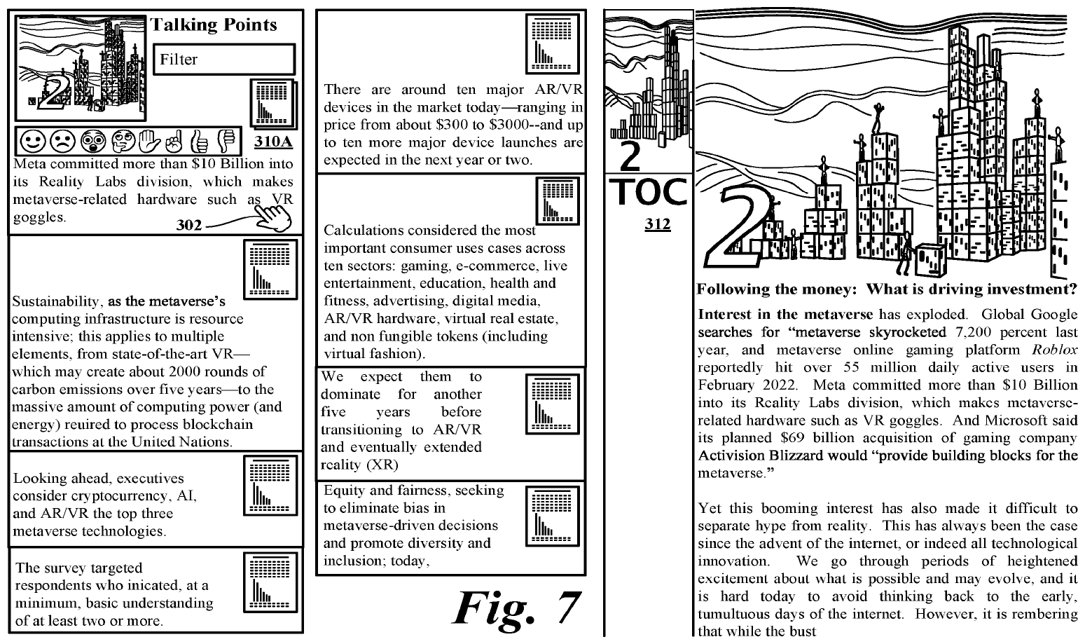

As best illustrated in FIGS. 5-7, the digital file associated with the icon 304 is accessed and parsed by a processing device, which may be associated with server 230 and/or client device 270. During this parsing process, a graphical illustration 306 may be generated within GUI 300 show the user that the file is being parsed. As a result of this parsing operation, an embodiment is able to generate within GUI 300 a table of contents, which contains what may be referred to as themes 308, characterizing the contents of the file. In an embodiment, selection by the user of a theme 308 can cause one or more portions of the file topically pertaining to the selected theme to be displayed in the GUI 300. Such file portions may be referred to as talking points 310. As shown in FIG. 7, selection by the user of a specific talking point 310A will cause GUI 300 to display for review by the user the portion 312 of the file corresponding to the selected talking point. In an embodiment, any one of the displayed talking points can be formatted as a sharable link.

### 1. Weave Assistant

An administrator/proprietor of one or more embodiments of the invention may be referred to herein throughout as Weave. To meet the needs of modern business, a new paradigm is needed. The AI-Powered Weave Research Assistant is a brand-new information paradigm that helps information users dramatically increase productivity, learn continuously, and make better and more timely business decisions. In an embodiment, Weave does this by using artificial intelligence (AI) to understand ever-evolving subject areas and to automatically curate timely, relevant content from a broad set of sources (excluding ‘fake’ content) across a broad set of information types (videos, podcasts, webinars, social media, etc.). In an embodiment, Weave also intelligently presents multimedia information contextually and visually—the way the brain likes to consume information.

In summary, one or more embodiments:
would help businesses drive revenue growth by teasing the signal from the noise and by helping to unlock new revenue opportunities;
empower all team members with 24/7 continuous learning about relevant subject areas, thereby boosting team collaboration, efficiency and regulatory compliance;
deliver orders of magnitude increases in employee productivity by automatically mapping, curating, connecting and updating subject-area information, so businesses can focus on making critical decisions.

One or more embodiments include the use of AI (specifically natural language processing and machine learning) to deeply understand the subject matter for a domain, to automatically extract context for a given subject area (by mining Wikipedia, white-papers, brochures, market research reports, financial reports, earnings call transcripts, etc.) and to automatically keep up with the domain as it evolves. Non-exhaustive examples of domains include the entire Tech industry, Cybersecurity, China, emerging markets, the global market for soybeans, the Retail sector, Blockchain, FinTech, and much more. This solves the “I don't know what I don't know” problem that typically plagues search engines and social media-most users don't know what to even search for or don't know the most insightful questions to ask, especially in new or very fast-changing domains.

One or more embodiments include the use of AI to automatically classify and rank content sources based on insight and authoritativeness—across media types (videos, podcasts, webinars, social media, Web articles, blogs, etc.). Today's media platforms are saturated with content that is aimed at maximizing clicks and eyeballs, and not necessarily aimed at maximizing the delivery of insight to users. If one takes cryptocurrencies as an example there is an avalanche of so-called “industry insights” from numerous sources of dubious quality. The advertising economy encourages click-bait and content quantity, not quality. In contrast, to know which questions to ask and then to tease the signal from the noise is critical to business users. Oftentimes the two most critical questions in business are: what's next? Given what's next, what matters?

One or more embodiments include the use of AI to discover relevant content based on the extracted domain model and the classified/ranked content sources using sophisticated relevance and ranking algorithms. For instance, for the Cybersecurity domain Weave performs semantic disambiguation to distinguish between a highly relevant video by the company ‘Intel’ and another video on cyber-related ‘Intel’ based on reports from the intelligence community.

One or more embodiments include an AI-powered recommendations engine to generate Top Picks-updated, for example, every 12-24 hours. Weave users supervised machine learning to build a predictive model to automatically determine whether a given video, tweet, blog, etc. will deliver insight. The model includes features such as the content source, the presence of thought leaders (from the extracted domain model), the length or duration of the content (based on the content type), the number of people featured (an indication of a roundtable discussion), the indication of multiple featured topics (an indication of a cross-fertilization of ideas which is usually—but not always—indicative of insight), etc. Weave also aims to present diverse insight and the model is trained to be divergent (without going off-topic) rather than convergent—which is a problem that has been widely reported as a problem with traditional online media (this is now known by the term “filter bubble”).

One or more embodiments include the intelligent presentation of said content via a dynamic storyboard in a manner that aligns the delivery of content with how today's consumers prefer to consume content: Visual, Interactive, Mobile, Personalized and Snackable (via bite-sized content pieces). As a result, Weave delivers a 55× increase in engagement relative to traditional media.

Weave solves many shortcomings of prior information media:
1.) Intelligent domain understanding and modeling-mining unstructured data (whitepapers, research reports, Wikipedia, etc.) to build a domain model that captures the context in a given subject area
2.) Intelligent context extraction using natural language processing, semantic analysis and semantic disambiguation
3.) The intelligent discovery, ranking, classification and scoring of content in a variety of formats—webinars, industry videos, podcasts, news articles, blog posts, social media, etc.
4.) Visual and contextual storytelling—the presentation of a smart, interactive research report for any given domain. The report “understands” the domain, displays relevant context, displays trending context, delivers a smart, interactive, mixed-media dashboard combining multiple forms of relevant content, has a Picture-in-Picture interface to allow for video viewing even while the user is reading, and has contextual feeds allowing the user to discover content (including relevant videos) in context. The smart, interactive research reports deliver a two orders of magnitude boost in engagement and time savings and are updated every 12-24 hours.
5.) Intelligently rendering of transformed content on a variety of devices that employ different interaction models (including voice interfaces and virtual/augmented reality platforms).
6.) The automatic linking of the transformed content into an intelligent contextual network.
7.) Intelligent and context-aware user personalization of delivered content. This includes a Top Picks recommendation engine that users supervised machine learning to distill millions of content pieces and pick the very, very best videos, social media, and other content that a user should focus on.
8.) Intelligent, contextual analytics—the ability to accurately and specifically measure user interaction behavior based on intelligent context and use said analytics for intelligent content planning, demand alignment and personalization.

An embodiment is a brand-new information medium—marrying AI, semantic discovery, an intelligent content recommendation engine, visual storytelling and the cloud. Weave has built a complete information discovery and publishing stack from the ground up:
1.) The automated processing of static unstructured data (whitepapers, research reports, Wikipedia, etc.) to “understand” a given domain (China, the Retail sector, blockchain, cybersecurity, emerging markets, etc.) and build a domain model—this involves the automated extraction of context, semantic analysis and semantic disambiguation
2.) The automated generation of a “script” which forms the basis of a semantic index of the unstructured document inputs
3.) The processing of the script to automatically gather relevant content from around the Web—videos, related media, social media, etc.
4.) Automated content scoring and ranking using machine learning—to ensure that only content from authoritative sources (and based on real-time user engagement feedback) is included in the final storyboard
5.) The generation of a “manifest” which is independent of any specific rendering device
6.) The dynamic rendering of the manifest to various devices—the Web, mobile, the Apple Watch, voice interfaces like Amazon Alexa and Google Assistant, and virtual/augmented reality. Rendering is done visually, contextually, dynamically and automatically. Relevant contextual information is also displayed all in one place, obviating the need for users to keep searching for related information. User engagement is unprecedented with some Weaves (the resultant storyboards) getting up to 2 hours of user engagement with highly insightful business information.
7.) The real-time analysis of a user's interaction with the storyboard and the real-time personalization of rendered content based on the user's interaction behavior

In terms of ease of use an embodiment is represented as a visual storyboard (per domain or subject area) with cards representing context. Clicking a card opens a dynamic feed of videos and social media for that context. Contextual cards are added on the fly as the AI engine discovers new topics, thought leaders, markets, etc. within the subject area. This empowers users with intelligent discovery—users never have to search—the information comes to them contextually. The UI also has a Picture in Picture (PiP) feature allowing the user to watch videos even while reading documents and articles on the same unified canvas. This dramatically boosts engagement and productivity—users no longer must open a slew of browser tabs to attempt to read articles, blog posts, etc. (a process which Forbes estimates will take the average user two hours to perform, with no other work being accomplished in the process). The emphasis on mixed media (especially videos) and the Picture-in-Picture (PiP) interface allows the user to multitask and consume relevant media even while working on a document or responding to an email. The product also includes Top Picks—which uses machine learning to distill only the very best videos, social media, etc. This addresses the discovery-distillation information crisis—oftentimes busy business professionals don't know what they don't know and don't know what to search for. And then search and social media only serve to dump hundreds of articles, blog posts, tweets, LinkedIn notifications, etc.—in mostly textual formats that users simply have no time to read or consume. An embodiment helps business users discover what matters in a given domain and distills what matters most via the Top Picks recommendation engine that deeply understands the nuances of the domain. The Weave design also supports voice interfaces (particularly Amazon Alexa, Google Home, Cortana and Siri) that are tied to a domain-aware AI backend. Imagine a user asking the following:

What's trending in Cybersecurity (with the voice assistant streaming a playlist of webinars, podcasts, thought leader interviews, etc.)?

Play the latest webinars on ethical issues relating to AI.

Does Jim Cramer have any new insights on the Retail sector?

Are there any new fireside chats or roundtable discussions involving venture capitalists in Tech?

What's new on public sector applications of Blockchain and smart contracts?

One or more embodiments include a brand-new information medium—marrying AI, semantic discovery, an intelligent content recommendation engine, visual storytelling and the cloud. One or more embodiments include a complete information discovery and publishing stack from the ground up:
1.) The automated processing of static unstructured data (whitepapers, research reports, Wikipedia, etc.) to “understand” a given domain (China, the Retail sector, blockchain, cybersecurity, emerging markets, etc.) and build a domain model—this involves the automated extraction of context, semantic analysis and semantic disambiguation
2.) The automated generation of a “script” which forms the basis of a semantic index of the unstructured document inputs
3.) The processing of the script to automatically gather relevant content from around the Web—videos, related media, social media, etc.
4.) Automated content scoring and ranking using machine learning—to ensure that only content from authoritative sources (and based on real-time user engagement feedback) is included in the final storyboard
5.) The generation of a “manifest” which is independent of any specific rendering device
6.) The dynamic rendering of the manifest to various devices—the Web, mobile, the Apple Watch, voice interfaces like Amazon Alexa and Google Assistant, and virtual/augmented reality. Rendering is done visually, contextually, dynamically and automatically. Relevant contextual information is also displayed all in one place, obviating the need for users to keep searching for related information. User engagement is unprecedented with some embodiments (the resultant storyboards) getting up to 2 hours of user engagement with highly insightful business information.
7.) The real-time analysis of a user's interaction with the storyboard and the real-time personalization of rendered content based on the user's interaction behavior

In terms of ease of use it the product is represented as a visual storyboard (per domain or subject area) with cards representing context. Clicking a card opens a dynamic feed of videos and social media for that context. Contextual cards are added on the fly as the AI engine discovers new topics, thought leaders, markets, etc. within the subject area. This empowers users with intelligent discovery—users never have to search—the information comes to them contextually. The UI also has a Picture in Picture (PiP) feature allowing the user to watch videos even while reading documents and articles on the same unified canvas. This dramatically boosts engagement and productivity—users no longer must open a slew of browser tabs to attempt to read articles, blog posts, etc. (a process which Forbes estimates will take the average user two hours to perform, with no other work being accomplished in the process). The emphasis on mixed media (especially videos) and the Picture-in-Picture (PiP) interface allows the user to multitask and consume relevant media even while working on a document or responding to an email. The product also includes Top Picks—which uses machine learning to distill only the very best videos, social media, etc. This address the discovery-distillation information crisis—oftentimes busy business professionals don't know what they don't know and don't know what to search for. And then search and social media only serve to dump hundreds of articles, blog posts, tweets, LinkedIn notifications, etc.—in mostly textual formats that users simply have no time to read or consume. An embodiment helps business users discover what matters in a given domain and distills what matters most via the Top Picks recommendation engine that deeply understands the nuances of the domain. An embodiment also supports voice interfaces (particularly Amazon Alexa, Google Home, Cortana and Siri) that are tied to a domain-aware AI backend. Imagine a user asking the following:

What's trending in Cybersecurity (with the voice assistant streaming a playlist of webinars, podcasts, thought leader interviews, etc.)?

Play the latest webinars on ethical issues relating to AI.

Does Jim Cramer have any new insights on the Retail sector?

Are there any new fireside chats or roundtable discussions involving venture capitalists in Tech?

What's new on public sector applications of Blockchain and smart contracts?

New sales reps need to be able to ramp very quickly to drive revenue growth especially in the current environment with near full employment (for which many new sales reps are recruited with very diverse industry backgrounds). Marketing professionals need access to information while researching new markets or writing whitepapers. HR executives are eager to effectively onboard, train and retain employees in an era of extremely high competition for talent and spiraling recruiting costs. Executives need the equivalent of the US President's ‘President's Daily Brief’ (PDB)—that distills the mountains of intelligence field reports into an intelligently summarized and contextualized report of what most requires their precious attention.

### 2. Spotlight

To take one of many examples, compliance is a mission-critical business process in many businesses. For instance, in financial services alone, there are now over 2500+ compliance rule books globally and an average of 150 regulatory alerts are issued daily by over 900 regulators around the world. Up to 15% of the employee base at large banks is now devoted solely to compliance—manual review of compliance mandates and validating internal processes. Despite the drudgery and the costs involved, businesses have no choice: since the global financial crisis, financial services firms have paid around 350 billion dollars in misconduct and mismanagement fines globally. And in addition to this the cost of non-compliance is also reputational.

According to Thomson Reuters, the annual volume of regulatory updates increased by 492% from 2008 to 2015. JWG, a London-based think tank that focuses on financial regulation, has estimated that over 300 million pages of regulatory documents will be published by 2020.

Regulatory change management is also a major pain area for banks as compliance regulations are extremely dynamic. New regulations are being enacted by regulators and changes made to existing ones very frequently. As such, compliance reviews are not only time-consuming, but they need to be repeated almost constantly.

The same applies in other heavily regulated industries such as healthcare.

Businesses spend over $100B annually on analyst reports yet less than 1% of these reports are ever read (Quinlan). Businesses now face a dilemma—they need these reports in order to help guide business decision-making, yet they simply have no time to digest them all. The average analyst on Wall Street now covers over a hundred stocks—each with an avalanche of SEC filings, annual reports, earnings call transcripts, investor relations updates, etc. Multiply all this by 100 and that is what a single analyst needs to be able to digest in order to serve wealth management clients or guide investment decisions in the many millions of dollars. The result: many analysts give up and end up making investment recommendations with little or no due diligence.

Many companies also have hundreds of thousands of contracts that must be manually reviewed every year. For instance, telecom giants need to review volumes of real estate contracts for base stations, cellular towers, etc. This is currently a very painful, manual process.

By automating the review of business documents, an embodiment, which may be referred to herein throughout as Weave Spotlight, increases efficacy, saves time, and reduces costs. When multiplied by the huge volumes of reports that MUST be reviewed in many industries—especially heavily regulated ones—the ROI grows to orders-of-magnitude.

Text is the easiest format to mass-produce at scale but is the slowest for the brain to process. Weave Spotlight solves this dilemma. It is an enabling technology that dramatically improves the efficacy of existing business processes.

One or more embodiments include a revolutionary, SaaS-based AI-powered Spotlight service that uses AI to help businesses dramatically improve business decision-making by quickly and efficiently analyzing, summarizing, interpreting, contextualizing and converting oceans of hitherto unread reports into an easily digestible, interactive, blended report (called a ‘Weave’) containing key business, investment, marketing and customer insights. Weave can also be used to automate the review of contracts, compliance mandates, legal opinions, policy proposals, 2000-page pieces of legislation on Capitol Hill and much more.

A key differentiator vs. traditional summarization tools is that an embodiment combines a variety of AI techniques—sentiment analysis, topic modeling, semantic analysis, natural-language-processing, natural-language-generation, etc. to provide the user with a rich array of ‘dials’ to navigate and discover key insights in very long reports. Indeed, we believe that there is no such thing as a ‘canonical summary’ of a report—different users might have different needs and come from different perspectives. A Finance person reviewing an annual report might view it from a very different perspective than a CEO or a VP of Sales or HR. A Democrat might ‘summarize’ the Mueller report very differently from a Republican. Weave Spotlight does not pre-judge the user's intent; rather the user is given topic maps, sentiment dials, key takeaways, visual takeaways, etc. to explore and discover their own paths and takeaways based on their needs, interests, and perspectives.

Weave Spotlight takes an input—any document of any length on any topic for any business process—and transforms it into a revolutionary format with only the most timely, interesting factoids, infographics, charts, trends, key takeaways, etc. In addition, with Weave Spotlight, you can literally email us any question in any sector relevant to your business—in plain natural language. Our AI service will then auto-curate a customized report with only the most timely, interesting factoids, infographics, charts, trends, key takeaways, etc.—intelligently summarized from tens of thousands of relevant research/analyst reports from the top analyst firms, investment research reports, government reports, vendor whitepapers, academic papers, R&D and innovation reports, and much more. For example, business users or executives can email us: What is the possible impact of Brexit on European bonds? Is the inverted yield curve likely to lead to a recession? How are the big banks investing in FinTech applications of Blockchain?

The Weave Spotlight service comprises: 1.) Weave Research Cloud: a vast, comprehensive AI index of sector-specific market research reports, investment analyst research reports, VC reports, private equity reports, policy & regulatory reports, product whitepapers and brochures, investor relations (IR) reports and webcasts (earnings calls, annual reports, and other IR content from all public companies), corporate announcements and press releases, industry news/blogs, industry videos/webcasts, and much more. 2.) Weave Document X-ray and Audio-Video X-ray: groundbreaking, patent-pending AI technology—machine learning, natural-language-processing, and computer vision—providing a brand-new paradigm for identifying salient fragments of documents, presentations, and videos, 3.) Weave Document Navigator: a revolutionary user-interface for helping users quickly and intelligently navigate long reports (annual reports, 300-page policy reports by the Federal reserve, analyst reports, etc.), 4.) Weave Conversational Q&A: groundbreaking semantic indexing technology accessed via a conversational Q&A interface, 5.) Weave Cheat Sheets: a patent-pending interactive, blended report format that ‘weaves’ together salient content fragments from the research cloud.

The Weave Document Navigator uses AI to allow the user to navigate a report contextually and visually—akin to Google Maps for a document. The Document Navigator allows the user to filter by:
1. Specific pages of the document
2. Interestingness
3. Sentiment
4. Visual engagement (a very powerful way to quickly find interesting charts and infographics in a very long report)
5. Perspective (e.g., an entire sector, thought leaders, etc.)
6. Key takeaways—these are factoids extracted from the document using NLP
7. Financial takeaways—a subset of key takeaways with only financial factoids (particularly useful when reading financial statements)
8. Topics

The user will be able to navigate using a combination of the above. For instance, you might want to view the key takeaways for only a section of a 200-page research report or only the key takeaways for positive sentiment sections of an earnings call.

Businesses spend over $100B annually on analyst reports yet less than 1% of these reports are ever read (Quinlan). Businesses now face a dilemma—they need these reports in order to help guide business decision-making, yet they simply have no time to digest them all. Weave's AI-powered Spotlight intelligently understands, summarizes and synthesizes analyst and research reports to create smart, interactive blended reports called ‘Weaves.’ Weave's value propositions are a.) orders of magnitude increases in productivity, b.) vast content selection, providing much broader insights, c.) significant cost savings relative to traditional (human-powered) research services, d.) higher quality based on advanced AI, e.) increased content leverage for EXISTING spend on analyst reports, f.) compliance—the recent MIFID II regulations now make demonstrating research efficacy a compliance issue for fund managers.

Use cases include investment research, helping wealth managers automate client-communications and interactions, compliance audit automation, public policy research automation, innovation-based market intelligence, and competitive intelligence.

Weave Spotlight doesn't aim to replace human analysts; rather it eliminates a huge amount of drudgery—formulating the right questions, reading/digesting numerous reports each of which can be hundreds of pages long, or listening to thousands of investor webcasts and earnings calls—and frees human analysts to spend their time on true analysis. You send us an inquiry—any inquiry—and you get back a beautiful, comprehensive, intelligently organized report. It's that simple.

In Finance, to take one example, over 100,000 analyst and market reports are emailed by brokers every week (Quinlan). Yet less than 1% of these reports are ever read. Businesses face several huge and growing challenges: 1.) How do we better inform business decision-making—a pending investment by a hedge fund, a go-no-go decision as to whether to fund a new business unit, M&A due diligence, etc.—yet avoid getting buried by reports we can never have the time to read. 2.) How do we efficiently identify the salient insights buried deep within reports containing 100s of pages, 3.) How do we expand our data canvas of potential insights—beyond relying on a handful of research analyst firms, 4.) How do we increase business agility by speeding up inquiry-to-analysis turnaround times? 5.) How do we maintain or increase regulatory compliance, such as the new MIFID II regulation in the case of investment research?

The recent MIFID II regulations now make demonstrating investment research efficacy a compliance issue for fund managers. According to the Financial Times, “Until now, asset managers received [research] for free, although the cost of this service was built into trading fees, which are usually paid by fund managers' clients. For the first time, fund managers will have to budget separately for research and trading costs, a move known as unbundling. [Furthermore, they must regularly assess the quality of the research that they are receiving from third parties.]”

By creating intelligently navigable digests of the oceans of reports Weave helps fund managers a.) better leverage their internally generated reports (which lessens compliance risk exposure, b.) demonstrate external research usage to regulators (fund managers cannot assess the quality of the research they receive if they can't even digest it in the first place).

The Weave Spotlight uses advanced AI to transform reports—financial reports, SEC filings, market research reports, investment research, brokerage reports, compliance mandates, court opinions, legal documents, product brochures, white-papers, contracts, leases, etc.—into a format that is navigable and digestible. The Spotlight identifies key insights (takeaways) from reports that are hundreds or thousands of pages long, contextualizes said insights into topics, and allows the user to follow their own path in the document to explore takeaways. The takeaways are automatically grouped/clustered by page in order to ensure coherence (this is usually a very hard problem and often plagues automatic summarization algorithms).

The SPOTLIGHT breaks up a document into:

Themes—sections of the document that the user wishes to focus on. The user can manually select pages he/she wishes to focus on (for instance, a financial analyst might only want to focus on a particular section of an SEC filing). Alternatively, the user can have the SPOTLIGHT automatically filter the sections of the document according to topic, ‘perspective’ (e.g., a technological, legal, or regulatory perspective or an industry-wide perspective for any industry), sentiment or engagement (interestingness or visual interest).

Insights—these comprise of key takeaways, salient points that the AI engine automatically picks out of the document. Again, the takeaways are clustered by page. The Insights themselves can be filtered by Topic, by sentiment or by volume. The volume control essentially allows the user to control how many takeaways are displayed. In other words, how much time do you have to spend? Each takeaway is scored for saliency so if you dial back the volume, only the “most key” key takeaways are displayed.

Topics—the Topics view displays a cloud of phrases/words relevant to the user's question. For instance, what drove negative earnings with Tesla? Click Earnings theme, select negative sentiment for takeaways, and then view the cloud.

Viewer—this is the PDF document itself, broken up into pages to allow the user to navigate to the specific relevant page containing a takeaway. Click on an insights/takeaway postcard to navigate to the relevant page containing that set of insights.

The distinction of Themes vs. Insights is critical from a philosophical standpoint. For instance, in the Mueller report, not all themes about, say, Paul Manafort, have takeaways featuring Paul Manafort. A Paul Manafort theme might include takeaways featuring who he partnered with, spoke with, etc. This is critical in order to discover takeaways that are related to (or near) the theme selected by the user. The user can then further refine the takeaways from there.

Similarly, the user can select a negative theme (with the sentiment slider) but view all takeaways. A positive takeaway in a section of the document with a negative theme is the canonical definition of a silver lining. If the user wishes to see only negative takeaways, there is a sentiment slider specific to takeaways.

Another critical philosophical point: One of the problems with traditional summarization systems is that there is nothing like a “canonical summary,” especially for a long report. People want different things in a report. The same report might be viewed from a different perspective by a knowledge worker vs. an executive or by Finance vs. Legal vs. HR. The same applies to policy documents or legislation: if you get 100 people in a room they wouldn't agree to what the “summary” of the Mueller report is.

The Weave Spotlight allows you to navigate your own path—based on your own interests, perspectives, job function, politics, whatever—and then to discover and curate your own summary.

This is a critical unique selling proposition (USP) and distinction from a competitive standpoint.

Note that there are also visual takeaways. For instance, you can use the Visual slider (under Engagement) to find the coolest charts and infographics in a long report. The SPOTLIGHT uses computer vision (via a proprietary set of convolutional neural networks) to identify and score sections of a report with very interesting visuals.

One last thing before the demos: this technology essentially enables programmable documents. Entire corpora of documents can now be analyzed in a data warehouse. A hedge fund manager can now ask: from all the tens of thousands of investment and brokerage reports I buy every year, notify me if there is a sudden spike in negative takeaways related to fixed income.

Or a sales rep at a Cybersecurity firm can now ask (of the Weave Research Cloud): notify me when there are new and very cool charts or infographics on malware attacks in the healthcare sector—so I can embed them in my documents or slides before meeting with a customer prospect.

Another future application: the SPOTLIGHT essentially extracts the ‘DNA’ of the document—the themes, insights, key takeaways, cool visuals, etc. form a ‘document fingerprint.’ This can be used to compare versions of contracts, legal documents, filings, etc. but in a way that ignores minor changes in boilerplate. Comparing the SPOTLIGHT fingerprints will detect if there are material changes to the versions of a report OR even regularly updated reports filed quarter after quarter or year after year.

### Examples

A 611-page annual report by Goldman Sachs:
Raw PDF: https:/www.goldmansachs.com/investor-relations/financials/current/annual-reports/2017-annual-report/annual-report-2017.pdf
Weave: https://analyst.weave.me/?6p_FWRRBcEKxyjK_F_8gZw

The 2018 Intel annual report (great case for using the visual slider because it has a lot of cool infographics):
Raw PDF: https://s21.q4cdn.com/600692695/files/doc_financials/20018/Annual/Intel-2018-Annual-Report_INTC.pdf
Weave: https://s21.q4cdn.com/600692695/files/doc_financials/2018/Annual/Intel-2018-Annual-Report_INTC.pdf

A 2019 monetary policy report by the Federal Reserve:
Raw PDF: https://www.federalreserve.gov/monetarypolicy/files/20190222_mprfullreport.pdf
Weave: https://analyst.weave.me/?qxeSNYTcBOKHh2AEE0VDbA

Facebook's fourth quarter earnings call transcript:
Raw PDF: https://s21.g4cdn.com/99680738/files/doc_financials/2018/Q4/Q4-2018-earnings-call-transcript.pdf
Weave: https://analyst.weave.me/?z_paJnQ9wEKwz4ohIZpAkQ

Analyst report by Deloitte on recent banking regulations:
Raw PDF: https://www2.deloitte.com/content/dam/Deloitte/us/Documents/regulatory/us-banking-regulatory-outlook-2019.pdf
Weave: https://analyst.weave.me/?PvC2MO6HYUSVOtmjQo76kA

Uber S-1 filing:
Raw PDF: https://s3-us-west-2.amazonaws.com/weave.me/reports/Uber-S1.pdf
Weave: https://analyst.weave.me/?wOu4IzlgTk6ofmRlgMdJ9A Lyft S-1 filing:
Raw PDF: https://s3-us-west-2.amazonaws.com/weave.me/reports/Lyft-S1.pdf
Weave: https://analyst.weave.me/?hP2TkPctEEK4g6FS6iV6-w

Very recent US Supreme Court opinion featuring Apple:
Raw PDF: https://www.supremecourt.gov/opinions/18pdf/17-204_bq7d.pdf
Weave: https://analyst.weave.me/?jrybFqC9h0KCoILNRXqXFg

And finally, the 448-page Mueller report:
Raw PDF: https://www.justice.gov/storage/report.pdf
Weave: https://analyst.weave.me/?gk6fhEstpkyQb2xEtfuXgw

### 3. Spectrum Engage

According to Bloomberg Intelligence global AUMs are projected to exceed $150T by 2025, fueled in large part by millennials and the ongoing $68T transfer of wealth, the largest in history. Trillions of newly transferred wealth are at stake and asset managers that invest in deepening client relationships and offering compelling products and experiences to new prospects will be in an extremely strong competitive position in the years and decades ahead.

What constitutes a huge opportunity to grow AUMs also carries risk: 75% of millennials, long sensitized to modern and highly engaging consumer tools, now demand instant, on-demand engagement to win or keep their business. Given that we are still navigating a global pandemic wherein face-to-face interactions are few and far between, being able to automate and enrich digital client engagement with digitally savvy investors is even more mission critical.

As a result, asset managers must fundamentally change how they engage with investors. However, asset managers oftentimes continue to bombard prospects, clients, advisors, internal teams, and other stakeholders with long, arcane reports that no one can ever have time to read. This results not only in client and stakeholder frustration but also that vast amounts of organizational knowledge—typically created or purchased at great cost—are never leveraged to better engage or retain clients. To illustrate this a recent study by Quinlan group found that of all the investment reports asset managers create, purchase or distribute, less than 1% are ever read.

One or more embodiments include advanced AI to analyze asset managers' ETFs, mutual funds, fixed income funds, etc., in addition to client proposals, presentations, and entire portfolios, and distill out only the most relevant facts, graphics, and trends—called smart talking points—to help more rapidly build personalized, compelling stories for each client, prospect, advisor or stakeholder. This turbocharges client acquisition, engagement and retention and drives AUM growth. These stories—called ‘Weaves’—are snackable, digestible, interactive, and measurable, a format optimized for digital engagement, personalization and retention.

Weave.AI allows investors to dive deep into long, arcane reports—fund prospectuses and other reports, related investment research, related earnings calls and webcast transcripts, related annual reports, quarterly reports, ESG reports, regulatory filings, etc.—on a fund and its holdings. The Weave.AI Knowledge Graph also categorizes smart talking points based on context, investment risks and opportunities—allowing investors to view and personalize talking points on the fund and the securities therein, intelligently ranked by materiality.

Investors can also switch contexts to learn the most material talking points on said securities from an earnings context, emerging markets, or even thematic contexts (e.g., cybersecurity or space, in the event of a thematic fund) and further spot talking points that represent risks or opportunities. This is very powerful as investors can then juxtapose their analysis of specific themes or factors (such as ESG) with more traditional investment analysis concerns. This in turn drives client engagement, loyalty and retention and helps grow AUMs.

Weave.AI turbocharges client engagement by orders of magnitude (up to 1000×) and facilitates customer referrals. High net worth individuals (HNWIs) tend to be extremely busy; as such arming them with highly engaging Weaves they can use—to evaluate proposals, ideas, and portfolios quickly yet thoroughly—helps drive client loyalty, referrals, and AUM growth.

All this applies not only to retail investors but other key audiences that are critical to growing AUMs: institutional investors, financial advisors, fund gatekeepers that screen and onboard funds to their advisors and clients, and even to regulators. For instance, an asset manager can use Weave.AI to semi-automate the due diligence and screening of the ever-mushrooming number of third-party funds it wishes to onboard to its internal advisors and clients.

Weave.AI can also be used by asset managers to unearth investment ideas and to create and distribute more engaging, interactive, and insightful client proposals, said ideas, presentations, and client reports. And by facilitating a self-service, personalized approach to investment-related question-answering and decision-support, this also reduces asset managers' customer service costs. Weaves can also be used by asset managers for internal knowledge sharing, sales enablement, and customer support.

Unlike traditional distribution formats (typically PDFs) which are black boxes that provide no feedback into client behavior or specific interests, Weave.AI's smart and engaging talking points—annotated with ‘themes’—facilitate much richer, reliable, dynamic, friction-free, and real-time insights into customer profiles and personas, even as customers' lives change, often unpredictably. This facilitates client propensity modeling and personalized marketing which deepens client engagement and helps grow AUMs.

Engagement insights also helps customers understand specifically which topics drive engagement—and which do not—thereby increasing the ROI on costly content spend.

Asset managers must fundamentally change how they engage with investors. However, asset managers oftentimes continue to bombard prospects, clients, advisors, internal teams, and other stakeholders with long, arcane reports that no one can ever have time to read. This results not only in client and stakeholder frustration but also that vast amounts of organizational knowledge—typically created or purchased at great cost—are never leveraged to better engage or retain clients. To illustrate this a recent study by Quinlan group found that of all the investment reports asset managers create, purchase or distribute, less than 1% are ever read.

Weave.AI Spectrum Engage helps asset managers turbocharge client and stakeholder engagement and boost AUMs while lowering investment and regulatory risk. Spectrum Engage employs advanced AI to transform ETFs, mutual funds, ESG funds, client portfolios and client reports and distill out only the most relevant facts, graphics, and trends—called smart talking points—to help more rapidly build personalized, compelling stories for each client. This boosts client acquisition, engagement and retention and drives AUM growth. These stories—called ‘Weaves’—are snackable, digestible, interactive, and measurable, a format optimized for today's busy information consumer. Weave.AI customers are finding up to a 1000× increase in engagement relative to traditional approaches.

Weave.AI is totally cloud-based and is delivered via a very powerful SaaS solution.

A 2017 Harvard Business Review article focused on how Morgan Stanley was trying to leverage AI to deepen client engagement and better understand client needs. According to the article:

[Morgan Stanley] found, for example, that there was no artificial intelligence system available today that could take the knowledge embedded in investment analyst reports and make it available to support the choices presented to clients.

This is the problem that Weave.AI has solved.

Weave.AI is an automated cloud-based platform with a very user-friendly interface that scales massively to query billions of investment data points and delivered as a Software-as-a-Service (SaaS) solution. Weave.AI automatically transforms existing ETFs, mutual funds, prospectuses, reports, client portfolios, client presentations, client reports, and much more. Customers do not need to install anything on their servers. Customers that wish to identify smart talking points from their own research reports typically provide access to their repositories via industry-standard authentication and access-control protocols. In other cases, depending on the customer's comfort level, Weave.AI can securely store said reports in the cloud (via Amazon Web Services) with access-control safeguards and in encrypted form with rotating keys. Weave.AI also offers an API for customers that wish to integrate our data and analytics into their portfolio allocation models and other internal applications.

Weave.AI benchmarks and the Weave.AI Knowledge Graph are updated 24/7 with no burden on customers. Customers can also rapidly customize Weave.AI on multiple levels—via custom sectors or investment landscapes, custom themes, and custom reports.

Deepen client relationships and grow AUMs: Weave.AI helps asset managers deepen client relationships, boost customer loyalty, retention, and referrals, and grow AUMs. This is especially critical in an era of massive wealth transfer and with younger investors that have grown up with engaging, easy-to-use and fun-to-use digital tools. Weave.AI facilitates both client education and engagement, both of which are critical to enhancing customer relationships.

Many investors, especially HNWIs and ESG-conscious investors (a fast-growing cohort within the investor base), often wish to know precisely what companies they hold-even when these investments are made via ETFs and mutual funds. Yet these busy and information-drenched investors are expected to manually read ridiculous long prospectuses, other fund reports, and investment research reports that could be hundreds of pages long. And on top of all that clients and prospects often wish to analyze reports quickly yet thoroughly on their specific holdings to unearth the most material data points on those securities. Some investors might be particularly interested in new ideas, ESG-specific concerns, or might be trying to evaluate portfolio rebalancing scenarios. Yet trying to triangulate these specific investment concerns with mountains of reports that their funds contain is an impossible task. This often leads to client frustration and disengagement, and a loss of investor credibility.

Weave.AI completely automates this process—and is akin to arming clients, prospects, and other stakeholders with an intelligent investment AI assistant. Weaves include smart talking points, videos, sections on holdings, integrated report cards, etc. all in one place and eliminate the painful friction it takes to thoroughly evaluate and assess one's portfolio, fund, or investment ideas. Weave.AI customers have seen up to 1000× increases in client engagement.

Boost customer acquisition: Weave.AI enables much more engaging and insightful client presentations and interactive pitches, thereby helping boost customer acquisition.

Boost customer retention: According to a recent survey conducted by Ernst and Young, 33% of wealth management clients plan to switch wealth management providers over the next 3 years. Within the ultra-high net worth individual (UHNWI) cohort, this number increases to 39%. This implies that a significant portion of AUMs are under threat due to customer churn. Investing in customer loyalty and retention has never been more important. Weave.AI deepens client relationships and boost client loyalty, thereby enhancing customer retention.

Strengthen your competitive advantage: In era of increasingly commoditized asset management landscape, with an exploding number of ETFs and mutual funds, cutting through the noise and distinguishing oneself from the competition is as important as ever.

Guard against disruption: Even though robo-advice still constitutes a small portion of total AUMs, 39% of millennials currently use robo-advisors and 41% plan to use them soon, according to a recent Ernst and Young survey. Amongst the GenX cohort, these numbers increase to 44% and 51%, respectively. Given the ongoing transfer of wealth and as the millennial cohort becomes a bigger part of the entire investor pool, many investors will be much more comfortable with robo-advice. Asset managers must prepare for this eventuality by creating deeper and more engaging experiences for younger investors. Weave.AI does exactly this, by making investing and investment analysis thorough, productive, and insightful, yet fun and engaging.

Spot investment opportunities and reduce risk: Weave.AI helps investors spot risks and opportunities that might be buried in long reports and other data, thereby helping to reduce investment risks and identify opportunities that might otherwise have been missed.

Reduce costs, improve efficiency, and save time: It is literally impossible for an asset manager's analysts, sales teams, and advisor partners to manually read and analyze tens of thousands of reports—many of which are hundreds of pages long—and to do it accurately in one industry, let alone every single sector, to spot and recommend investment opportunities or identify risks. Weave.AI completely automates this process, with attendant time and cost savings (especially analyst-related labor costs). And for existing analysts, Weave.AI frees up their time to focus on higher-level tasks that require human judgement, rather than them spending time on drudgery.

Lower customer service costs: By facilitating a self-service, personalized approach to investment-related question-answering and decision-support, Weave.AI also helps reduce asset managers' customer service costs.

Improve internal knowledge sharing and decision-support: Weave.AI enables asset managers to share snackable, digestible, engaging talking points rather than long reports no one would ever read. This dramatically reduces friction in the internal knowledge sharing process-amongst investment teams—and enables much quicker, seamless decision-making.

Engagement and customer insights, and content spend optimization: Weave.AI also includes engagement analytics, providing asset managers with invaluable data on clients and prospects—a 360° view on their engagement levels, interests, and investment concerns. This facilitates personalized marketing which further deepens client engagement and helps grow AUMs. The Weave format, in concert with engagement analytics, also helps asset managers understand which of their distributed content pieces drive the most engagement, in order to optimize content spend and increase research-related ROI.

Weave.AI's ROI can be tested, demonstrated or proven in several ways:
1. Client engagement, client education, and AUM growth: this can be validated via A/B tests by comparing engagement levels using traditional formats (with outreach to retail investors, institutional investors, advisors, other stakeholders) with engagement levels using Weave.AI. The following KPIs can be measured and compared:
a. Email click-through rate (CTR)
b. Average time spent
C. Bounce rate
d. Documents and pages clicked
e. Most popular themes clicked
f Number of talking points clicked and opened
g. Popular talking point themes
h. Specific securities researched
i. Videos watched
j. Report cards opened
k. Total number of report cards opened
l. Total number of exit links opened
m. Total number of call-to-action (CTA) links opened
n. Funnel analytics and A/B test results:
i. Total number of users
ii. Total number of engaged users
iii. % Engaged users by engagement cohort
iv. #Users and % users converted
v. Average net promoter score (NPS)
a. Longitudinal studies that measure cohort-specific AUM growth over time
b. Customer surveys to measure customer satisfaction and trust
2. Time savings and estimated savings in labor costs (especially the cost to hire investment analysts)
3. Savings in customer service costs: these can be measured by examining the effect of Weave.AI on support rep throughput, the number of tickets handled per rep, and time-savings per rep. Ramping up self-service has a clear ROI on customer service and support.
4. Portfolio allocation efficacy—longitudinal A/B tests can test efficacy of competing portfolio allocation models
5. Predictive power—Longitudinal analyses can be performed to determine whether Weave.AI's investment risk and opportunity detection and forecasting actually predict changes in a company's stock performance or return on capital.

Overview: Weave.AI Spectrum Engage helps asset managers turbocharge client and stakeholder engagement and boost AUMs while lowering investment and regulatory risk. Spectrum Engage employs advanced AI to transform ETFs, mutual funds, ESG funds, client portfolios and client reports and distill out only the most relevant facts, graphics, and trends—called smart talking points—to help more rapidly build personalized, compelling stories for each client. This boosts client acquisition, engagement and retention and drives AUM growth. These stories—called ‘Weaves’—are snackable, digestible, interactive, and measurable, a format optimized for today's busy information consumer. Weave.AI customers are finding up to a 1000× increase in engagement relative to traditional approaches.

Weave.AI is totally cloud-based and is delivered via a very powerful SaaS solution.

A 2017 Harvard Business Review article focused on how Morgan Stanley was trying to leverage AI to deepen client engagement and better understand client needs. According to the article:

[Morgan Stanley] found, for example, that there was no artificial intelligence system available today that could take the knowledge embedded in investment analyst reports and make it available to support the choices presented to clients.

This is the problem that Weave.AI has solved.

Smart talking points: Weave.AI is the only solution we know of that can take arbitrary investment reports—webcast transcripts, earnings call transcripts, annual reports, press releases, regulatory filings (such as 10Qs), ESG reports, and other reports—of any length and in completely unknown visual layouts, and automatically extract key takeaways that retain fluidity and a narrative structure (even if the talking points straddle fuzzily laid out sections, subsections, heading and subheadings), intelligently identify and exclude boiler plate, organize and classify those key takeaways from a variety of perspectives based on a proprietary knowledge graph, and rank them by materiality. Weave.AI employs a proprietary combination of extractive and abstractive summarization and boiler plate detection to generate smart talking points that retain fluency even when sourced from arbitrary documents. This differs from traditional approaches which only tend to work on news articles that tend to have a non-random narrative flow. Smart talking points include key takeaways, material statements, key trends, investments, financial highlights, major accomplishments, strategic goals, key announcements, major events, forecasts, and other material highlights.

Smart talking points are also automatically organized by context or by perspective—which we call ‘semantic lenses’—using the Weave.AI Knowledge Graph described below. This is critical because one could argue that merely identifying talking points from reports, absent context, is largely meaningless. This is particularly the case with very long reports that are often an agglomeration of numerous perspectives, chapters, and topics.

Weave.AI also uses computer vision to automatically identify, rank and integrate key charts and infographics from long investment research reports—like how a self-driving car identifies pedestrians, bicycles, or traffic signs on the road. A Weave.AI smart talking point also automatically links to the relevant page in the relevant document from whence it came—this is critical so that the user can click on a talking point and navigate to the specific page for follow-up. This also is critical in building client trust (and for regulatory compliance) as it enhances transparency and explain-ability. Users can also copy and paste smart talking points to the clipboard and embed them in standard publishing tools (Word, PowerPoint, Excel, Google Docs, Microsoft Outlook, Gmail, etc.) and optionally send them via email to clients, prospects, regulators, or colleagues.

Semantic deduplication: Weave.AI intelligently deduplicates smart talking points. This is a non-trivial problem because not all duplicates (or possible typos) are created the same. For instance, many reports have seemingly redundant talking points that appear to be typos but where the subtle differences in the talking points are very material. Weave.AI infers and takes intentionality and materiality into account and intelligently (and safely) deduplicates talking points.

The Weave format, Weave compilation, and auto-synchronization: Weave.AI transforms funds, portfolios, client reports, client presentations, investment ideas, etc. into the Weave format, a modern, snackable, digestible, interactive, and measurable information format optimized for delivering quick bites of actionable insights and for engaging today's busy information consumer. Weave.AI automatically identifies and ‘compiles’ relevant smart talking points, videos, integrated report cards, etc., all in one place, and eliminates the painful friction involved in thoroughly evaluating and assessing one's portfolio, funds, securities, or investment ideas. Weaves are updated 24/7, ensuring that clients always have the most up-to-date information in their Weaves, in sync with the relevant data sources (funds, portfolios via CRM databases and other data sources, reports, etc.).

Weave.AI Knowledge Graph: Weave.AI's Knowledge Graph is a comprehensive database of investment-related topics, issues, technologies, organizations, and relationships. It provides the intelligent discovery of investment insights out of mountains of reports and authoritative news articles, automatically determines which issues are most material in each industry. The Weave.AI Knowledge Graph is automatically built using natural-language-processing—by analyzing millions of investment data points daily. This solves the “I don't know what I don't know” problem which is very common within the fast-changing investment landscape. The Weave.AI Knowledge Graph is updated 24/7 and its dynamic nature is critical because new investment-related issues might pop up out of nowhere. For instance, no one could ever have predicted the Covid-19 pandemic and how this could present investment risks. And no one could have predicted the chip shortage that is currently plaguing many industries, particularly the automotive industry. The Weave.AI Knowledge Graph automatically unearths investment-related issues as they occur—by detecting if an issue might have material investment impact and is starting to appear repeatedly in material sources (company disclosures on a global basis, investment webcasts run by sell-side analysts or authoritative news sources).

Seamless ESG integration: Weaves seamlessly link to Weave.AI report cards which are ESG report cards that highlight where companies stand relative to their peer group. ESG-conscious users can then easily explore these report cards without leaving the Weave—all in one place. This further boosts client engagement and helps build client trust.

Seamlessly integrated gap analysis: Users can also switch contexts within a report card to see how a company in the fund or portfolio is performing relative to its peers from a variety of perspectives (e.g., specific subsets of ESG—such as E, S or G, exposure to China, investments in digital transformation, or investments in renewable energy). This is critical in providing seamless decision-support right within the context of a Weave.

Investment question-answering: By inferring and annotating investment research reports, disclosure data from companies in a portfolio, metadata (including precise publication dates, a non-trivial problem), and the Knowledge Graph, Weave.AI enables extremely sophisticated investment question-answering (by asset managers, investors, or companies). For example: 1.) What investment opportunities exist in renewable energy in emerging markets? 2.) What are material talking points on interest rates from the latest Federal Reserve meeting notes? 3.) What investment risks exist relating to FinTech and the entire banking sector?

Smart investment alerts: Weave.AI also supports smart investment alerts—newly unearthed investment risks and smart investment talking points in newly published disclosures that meet certain criteria.

Semantic disambiguation and context: Weave.AI also understands the difference between ‘CHF’ the currency and ‘CHF’ in the context of congestive heart failure. This is a very hard problem. Unlike a search engine a knowledge graph cannot ask the user “Did you mean this or that?” A knowledge graph must be right. In addition, a knowledge graph provides the basis for semantic inference and programmability which means that errors can multiply very quickly. This constitutes an extremely high bar that requires very different algorithms relative to traditional approaches.

Semantic inference: In addition to understanding context, Weave.AI performs intelligent semantic inference to annotate talking points with what we call ‘parent themes.’ For instance, the country Turkey is a child theme and ‘Emerging Markets’ is a parent theme. If a smart talking point refers to the noun ‘Turkey,’ this might be country or the bird. Weave.AI's semantic disambiguation algorithms automatically infer that the talking point is referring to the country. However, to further infer that the talking point is referring to an emerging market, semantic inference is performed, and the algorithms compute additional scores as it traverses inferential hops. This is particularly critical with very broad parent themes like ‘Economic themes.’

Fully transparent investment report cards: Weave.AI's investment report cards are infographics that summarize a company's performance relative to its peer group, from a variety of investment-related perspectives (e.g., earnings, emerging markets, China, ESG, etc., including thematic perspectives such as cybersecurity). Weave.AI's investment report cards are deeply integrated with the Weave.AI Knowledge Graph and indicate precisely where a company is under-performing or over-performing relative to its peers, from a given investment perspective. These topics, called themes, are generated by the knowledge graph. Weave.AI's investment report cards are also fully interactive—the user can click on a particular peer to pivot from peer to peer, find out areas of underperformance or overperformance, from any personalized investment perspective, then click on those areas to determine the smart talking points corresponding to said areas. The smart talking points can then be clicked to navigate the user to the specific document where the company made said disclosure, and the specific page therein. This provides an end-to-end and fully transparent experience of investment benchmarking and analytics—as opposed to opaque black boxes that don't provide access to the underlying data.

Seamless peer discovery and analysis, and the global Weave.AI Knowledge Graph: Weave.AI investment report cards also allow the user to browse companies that are peers of a company in the Weave. For instance, an ETF Weave might have Disney as one of its holdings. The Weave would allow the user to view the Disney report card, view the other companies in Disney's peer group and drill-down into their performance from various investment perspectives. Furthermore, the global Weave.AI Knowledge Graph connects every security with every fund and includes other relationships (such as ‘peers’), thereby allowing the user to navigate from an ETF Weave to a company in that Weave to the peer of that company to the fund Weaves (e.g., other ETF Weaves or mutual fund Weaves) that that peer is included in. This global knowledge graph facilitates intelligent discovery, recommendations, and analytics.

Customizability: Weave.AI also allows asset managers to create custom themes for use in investment question-answering, benchmarking or for integration into Weaves that are distributed to clients, prospects, and other stakeholders. For instance, asset managers can create custom themes for emergent areas that map to investment ideas they wish to share with clients. Weave.AI automatically builds topic models for these themes and adds them to the Knowledge Graph. The themes can then be integrated into Weaves to generate smart talking points from very new and insightful contexts. Weave.AI also has groundbreaking technology called ‘ideas.’ Asset managers can publish ideas which are much more complex topic models. An example of an idea is ‘Investment opportunities in FinTech in emerging markets.’ These are not keywords or even themes—this is a very complex combination of themes that abstract out complex contextual interactions.

Weave Notes: Asset managers, clients, prospects and other stakeholders can create ‘notes,’ a powerful format that allows them to curate smart talking points, videos, report cards, charts and infographics, ESG data points, data points on specific securities, and much more, all in one place—in order to communicate to clients (or advisors and asset managers) in a much more powerful, engaging, interactive, friction-free, insightful and time-saving way. For instance, asset managers or advisors can create notes in advance of client presentations or meetings—this leads to much more effective meetings as the notes contain valuable context that obviate the need for the recipient to open or read long reports or manually perform arduous research. This in turns deepens client engagement.

Engagement analytics and customer insights: Unlike traditional distribution formats (typically PDFs) which are black boxes that provide no feedback into client behavior or specific interests, Weave.AI's smart and engaging talking points—annotated with ‘themes’—facilitate much richer, reliable, dynamic, friction-free, and real-time insights into customer profiles and personas, even as customers' lives change, often unpredictably. This facilitates client propensity modeling and personalized marketing which deepens client engagement and helps grow AUMs.

Content spend optimization: Engagement analytics also helps customers understand specifically which topics drive engagement—and which do not—thereby increasing the ROI on costly content spend.

1. Weave.AI employs advanced AI to analyze asset managers' ETFs, mutual funds, fixed income funds, etc., in addition to client proposals, presentations, and entire portfolios, and distill out only the most relevant facts, graphics, and trends—called smart talking points—to help more rapidly build personalized, compelling stories for each client, prospect, advisor or stakeholder. This turbocharges client acquisition, engagement and retention and drives AUM growth. These stories—called ‘Weaves’—are snackable, digestible, interactive, and measurable, a format optimized for digital engagement, personalization and retention.

2. Weave.AI allows investors to dive deep into long, arcane reports—fund prospectuses and other reports, related investment research, related earnings calls and webcast transcripts, related annual reports, quarterly reports, ESG reports, regulatory filings, etc.—on a fund and its holdings. The Weave.AI Knowledge Graph also categorizes smart talking points based on context, investment risks and opportunities—allowing investors to view and personalize talking points on the fund and the securities therein, intelligently ranked by materiality.

3. Investors can also switch contexts to learn the most material talking points on said securities from an earnings context, emerging markets, or even thematic contexts (e.g., cybersecurity or space, in the event of a thematic fund) and further spot talking points that represent risks or opportunities. This is very powerful as investors can then juxtapose their analysis of specific themes or factors (such as ESG) with more traditional investment analysis concerns. This in turn drives client engagement, loyalty and retention and helps grow AUMs.

4. Weave.AI turbocharges client engagement by orders of magnitude (up to 1000×) and facilitates customer referrals. High net worth individuals (HNWIs) tend to be extremely busy; as such arming them with highly engaging Weaves they can use—to evaluate proposals, ideas, and portfolios quickly yet thoroughly—helps drive client loyalty, referrals, and AUM growth.

5. Weave.AI can also be used by asset managers to unearth investment ideas and to create and distribute more engaging, interactive, and insightful client proposals, said ideas, presentations, and client reports. And by facilitating a self-service, personalized approach to investment-related question-answering and decision-support, this also reduces asset managers' customer service costs. Weaves can also be used by asset managers for internal knowledge sharing, sales enablement, and customer support.

6. Unlike traditional distribution formats (typically PDFs) which are black boxes that provide no feedback into client behavior or specific interests, Weave.AI's smart and engaging talking points—annotated with ‘themes’—facilitate much richer, reliable, dynamic, friction-free, and real-time insights into customer profiles and personas, even as customers' lives change, often unpredictably. This facilitates client propensity modeling and personalized marketing which deepens client engagement and helps grow AUMs.

7. Engagement insights also helps customers understand specifically which topics drive engagement—and which do not—thereby increasing the ROI on costly content spend.

8. This entire invention can also be applied in other business, government, and consumer contexts—to analyze and publish stories (called ‘Weaves’) featuring smart talking points automatically curated from out large amounts of unstructured data, and from a variety of perspectives, combined with additional data sources and formats, without having to manually read and analyze long reports—and is not just for asset managers or investors.

### 4. SPECTRUM Environmental, Social, and Governance (ESG)

According to Bloomberg Intelligence ESG assets are projected to top $53T by 2025, a third of global AUMs. Over 80% of millennial investors already invest or plan to invest based on ESG factors. Given the ongoing $68T transfer of wealth, the largest in history, ESG-conscious investors are likely to constitute an ever-increasing percentage of the global investor pool. In Europe alone, ESG fund AUMs are projected to top 50% of total mutual fund assets by 2025, representing a staggering 28.8% CAGR. According to Optimas, the ESG data market was projected to top $1B in 2021, is growing at a 35% CAGR, and is projected to top $5B by 2025. ESG benchmarking for companies is now mission and time-critical because companies' ratings directly impact their ability to attract shareholders, their ability to raise debt, and their cost of capital.

ESG has become top-of-mind for investors worldwide, with ESG assets projected to top $53T by 2025, a third of global AUMs. Over 80% of millennial investors already invest or plan to invest based on ESG factors. In Europe alone, ESG fund AUMs are projected to top 50% of total mutual fund assets by 2025, representing a staggering 28.8% CAGR.

However, investors remain frustrated by the lack of ESG disclosure standards, the prevalence of greenwashing, huge (and noisy) disclosure volumes, and opaque and inconsistent ESG ratings models. Furthermore, with the steady rise in ESG-related regulatory scrutiny in the EU and recent signals by the SEC, this has also become a compliance issue.

Trying to read mountains of ESG reports, manually evaluate the veracity of ESG claims, and then reconcile them with independent data sources is time-consuming, costly, extremely error-prone, and could easily lead to misinformed investment decisions.

Weave.AI solves this problem efficiently and cost-effectively. At lightning speed, asset managers can now benchmark securities and evaluate the materiality of ESG claims in a manner that is transparent, explainable, and fully customizable. They can more readily engage with clients, regulators, internal teams, and companies, while increasing compliance. Weave.AI automatically transforms long arcane reports—ESG reports, ESG webcasts, earnings call transcripts, annual reports, press releases, regulatory filings, etc.—into smart talking points, intelligently ranked by materiality, to help investors improve ESG portfolio allocation and better engage clients, stakeholders, and regulators.

Weave.AI's ESG Knowledge Graph automatically identifies and ranks which ESG issues are most material in a given industry, classifies smart talking points into said ESG ‘themes,’ and automates ESG question-answering. Gap analysis helps investors identify specifically where companies are under-performing relative to a variety of peer groups. Weave.AI also monitors and flags ESG-related risks from global news and alternative sources and helps inoculate investors from greenwashing by reconciling company claims (or silence) with independent reports on material risks by authoritative news sources. Weave.AI detects if there are ongoing, persistent ESG risks (or positive developments) involving a specific company and builds time-series models out of said news reports. These models can be used for predictive analytics to forecast changes in a company's ESG score.

Companies can also use Weave.AI to automate the ESG benchmarking process—to understand precisely where they need to improve.

Weave.AI also helps asset managers turbocharge client and stakeholder engagement, thereby boosting AUMs while lowering investment and regulatory risk. We are in the middle of a $68T transfer of wealth. Young investors are not only digitally-savvy but a whopping 72% of them want to know whether a company lives up to their values before they invest. As a result, asset managers must fundamentally change how they engage with ESG-conscious investors. However, asset managers oftentimes continue to bombard prospects, existing clients, advisors, internal sales teams, and other stakeholders (including regulators) with long, arcane reports that no one can ever have time to read. This results not only in client and stakeholder frustration but also that vast amounts of organizational knowledge—typically created or purchased at great cost—are never leveraged to better engage or retain clients.

Besides, many ESG investors might be particularly interested in specific ESG concerns like sustainability, human rights, or gender equality. Yet triangulating these issues with oceans of fund reports is an impossible task. With ever-present concerns about greenwashing this lack of transparency frustrates investors and can lead to client mistrust and disengagement, in turn hampering AUM growth.

Weave.AI employs advanced AI to analyze ESG ETFs and other funds, in addition to client proposals, presentations, and entire portfolios, and distill out only the most relevant facts, graphics, and trends—called smart talking points—to help more rapidly build personalized, compelling ESG stories for each client, advisor or stakeholder. This turbocharges client acquisition, engagement and retention and drives AUM growth. These stories—called ‘Weaves’—are snackable, digestible, interactive, and measurable, a format optimized for digital engagement, personalization and retention.

Weave.AI allows investors to dive deep into long, arcane reports on an ESG fund and its holdings. It also categorizes smart talking points based on context—allowing investors to view and personalize ESG-related talking points on the fund and the securities therein, intelligently ranked by materiality. Investors can specify which ESG ‘themes’ or ‘subthemes’—within E, S or G (not just E)—matter most to them. This is critical in earning investor trust, deepening client engagement and growing AUMs.

Investors remain frustrated by the lack of ESG disclosure standards, the prevalence of greenwashing, huge (and noisy) disclosure volumes, and opaque and inconsistent ESG ratings models. Furthermore, with the steady rise in ESG-related regulatory scrutiny in the EU and recent signals by the SEC, this has also become a compliance issue.

Trying to read mountains of ESG reports, manually evaluate the veracity of ESG claims, and then reconcile them with independent data sources is time-consuming, costly, extremely error-prone, and could easily lead to misinformed investment decisions.

Weave.AI solves this problem efficiently and cost-effectively. At lightning speed, asset managers can now benchmark securities and evaluate the materiality of ESG claims in a manner that is transparent, explainable, and fully customizable. They can more readily engage with clients, regulators, internal teams, and companies, while increasing compliance. Weave.AI automatically transforms long arcane reports—ESG reports, ESG webcasts, earnings call transcripts, annual reports, press releases, regulatory filings, etc.—into smart talking points, intelligently ranked by materiality, to help investors improve ESG portfolio allocation and better engage clients, stakeholders, and regulators.

Weave.AI's ESG Knowledge Graph automatically identifies and ranks which ESG issues are most material in a given industry, classifies smart talking points into said ESG ‘themes,’ and automates ESG question-answering. Gap analysis helps investors identify specifically where companies are under-performing relative to a variety of peer groups. Weave.AI also monitors and flags ESG-related risks from global news and alternative sources and helps inoculate investors from greenwashing by reconciling company claims (or silence) with independent reports on material risks by authoritative news sources. Weave.AI detects if there are ongoing, persistent ESG risks (or positive developments) involving a specific company and builds time-series models out of said news reports. These models can be used for predictive analytics to forecast changes in a company's ESG score.

Companies can also use Weave.AI to automate the ESG benchmarking process—to understand precisely where they need to improve.

1. Increase AUMs: ESG client engagement and client education are critical to growing AUMs. According to a New York Life Investments survey 72% of millennials want to know if a company lives up to their values before they invest. Weave.AI helps educate and engage prospects, clients, advisors, and other stakeholders with transparent ESG smart talking points—that inoculate asset managers from greenwashing—which deepen engagement and trust, in turn helping grow AUMs. Asset managers can also offer additional services to their corporate clients on top of our ESG platform, thereby driving sales growth.

2. Improve portfolio allocation and reduce investment risk: With the trillions of dollars poised to be invested in ESG in the months and years ahead the stakes are incredibly high. Poorly allocated portfolios that rely on poor or non-transparent data could result in massive investment losses and incredibly high opportunity costs. And this is supported by the data: according to a recent Schroders survey 60% of investors feel that greenwashing is the most significant obstacle to delivering on their sustainable investment goals and 48% of investors say a lack of transparency and reported data was restricting their ability to invest sustainably. Weave.AI's real-time ESG risk detection and ESG-related forecasting also helps asset managers monitor their portfolios for emergent ESG risks and opportunities, further reducing investment risk and improving opportunities for alpha.

3. Improve stewardship: Weave.AI enables asset managers to engage with companies that they invest in a much more insightful and transparent manner. Even if said companies have underwhelming ESG scores, the quality of these engagements is critical to working with them to improve over time. This helps reduce investment risk and attract more AUMs from institutional and retail investors that want to see their funds being managed properly.

4. Reduce regulatory risk and boost compliance: Weave.AI's smart talking points are ranked by materiality and are completely transparent and explainable (with links to underlying data). This is critical for asset managers to engage regulators to demonstrate that their funds or portfolios are indeed aligned with stated ESG goals and principles and are not being misstated due to greenwashing. Given the potential impact of the new EU SFDR regulations and the history of massive fines levied by regulators after the 2008 financial crisis, reducing regulatory risk is top-of-mind to compliance officers in the banking industry.

5. Reduce costs, improve efficiency, and save time: It is literally impossible to manually read and analyze tens of thousands of ESG and related reports—many of which are hundreds of pages long—and to do it accurately in one industry, let alone every single industry, custom peer group or sector that an asset manager needs to track. Unlike 5-10 years ago wherein ESG disclosures were few and far between, companies are now making ESG disclosures regularly, and in a multitude of reports (including ongoing ESG webcasts, quarterly filings, gender diversity reports, human rights reports, etc., in addition to annual ESG reports). And on top of that oceans of news data that must be sifted through to flag ESG-related risks and opportunities. Weave.AI completely automates this process, with attendant time and cost savings. As an illustration we estimate that asset managers will need to hire many dozens of ESG analysts per industry just to validate ESG claims, perform accurate benchmarking, etc. Weave.AI saves these labor costs. And for existing analysts, Weave.AI frees up their time to focus on higher-level tasks that require human judgement, rather than them spending time on drudgery. Weave.AI is also significantly cheaper than paying consultants millions of dollars to manually sift through company disclosures, an extremely slow and error-prone process. Lastly, because Weave.AI ESG Knowledge Graph allows users to build benchmarks from different perspectives, different teams can work efficiently and simultaneously in their evaluations—the sustainability team can focus on sustainability themes, HR teams can evaluate HR-related ESG issues, the marketing and brand purpose teams can focus on brand-impacting ESG issues, and so forth.

6. Improve internal knowledge sharing and decision-support: Weave.AI enables asset managers to share snackable, digestible, engaging ESG talking points rather than long reports no one would ever read. This dramatically reduces friction in the internal knowledge sharing process—amongst ESG investment and client support teams, senior executives, and Board members—and enables much quicker, seamless decision-making.

7. Brand benefits: In addition, the benefits listed above in turn help asset managers build their brands and employer brand, with attendant benefits in terms of brand value, hiring, employee engagement, and worker retention.

8. Saving the planet: Last but certainly not least, applying advanced technology to optimize how trillions of dollars in investment capital gets allocated is mission-critical in creating a more sustainable and equitable planet for ourselves, and perhaps most importantly, for our children and grandchildren who are poised to inherit a much more fragile environment in the years and decades ahead.
1. ESG client engagement/education and AUM growth: this can be validated via A/B tests by comparing engagement levels using traditional formats (with outreach to retail ESG investors, institutional investors, advisors, other stakeholders) with engagement levels using Weave.AI. The following KPIs can be measured and compared:
a. Email click-through rate (CTR)
b. Average time spent
c. Bounce rate
d. Documents and pages clicked
e. Most popular ESG themes clicked
f. Number of talking points clicked and opened
g. Popular talking point ESG themes
h. Specific securities researched
i. Videos watched
j. Specific ESG report cards opened
k. Total number of ESG report cards opened
l. Total number of ESG dashboard opens
m. Total number of exit links opened
n. Total number of call-to-action (CTA) links opened
o. Funnel analytics and A/B test results:
i. Total number of users
ii. Total number of engaged users
iii. % Engaged users by engagement cohort
iv. #Users and % of users converted
v. Average net promoter score (NPS)
p. Longitudinal studies that measure cohort-specific ESG AUM growth over time
q. Customer surveys to measure customer satisfaction and trust
2. Sales growth to companies
3. Surveys of regulators to measure satisfaction with ESG compliance mandates
4. Time savings and estimated savings in labor costs (especially the cost to hire ESG analysts)
5. ESG portfolio allocation efficacy—longitudinal A/B tests can test efficacy of competing portfolio allocation models
6. Predictive power—Longitudinal analyses can be performed to determine whether Weave.AI's ESG risk and opportunity detection and forecasting actually predict changes in ESG ratings
7. Brand-impact longitudinal studies—measuring corporate brand impact (on corporates in the asset manager's portfolio) and impact on the asset manager's brand

Overview: Weave.AI Spectrum ESG completely and transparently automates the ESG benchmarking and client engagement process—from oceans of unstructured ESG data, leveraging proprietary AI algorithms and the Weave ESG Knowledge Graph.

Weave.AI is totally cloud-based and is delivered via a very powerful SaaS solution.

Smart talking points: Weave.AI is the only solution we know of that can take arbitrary ESG and related reports—ESG reports, sustainability reports, diversity reports, climate impact reports, ESG-related webcast transcripts, earnings call transcripts, annual reports, press releases, regulatory filings (such as 10Qs), and other reports—of any length and in completely unknown visual layouts, and automatically extract key takeaways that retain fluidity and a narrative structure (even if the talking points straddle fuzzily laid out sections, subsections, heading and subheadings), intelligently identify and exclude boiler plate, organize and classify those key takeaways from a variety of perspectives based on a proprietary ESG knowledge graph, and rank them by materiality. Weave.AI employs a proprietary combination of extractive and abstractive summarization and boiler plate detection to generate smart talking points that retain fluency even when sourced from arbitrary documents. This differs from traditional approaches which only tend to work on news articles that tend to have a non-random narrative flow. Smart talking points include key takeaways, material statements, key trends, investments, financial highlights, major accomplishments, strategic goals, key announcements, major events, forecasts, and other material highlights.

Smart talking points are also automatically organized by context or by perspective—which we call ‘semantic lenses’—using the Weave.AI ESG Knowledge Graph described below. This is critical because one could argue that merely identifying talking points from reports, absent context, is largely meaningless. This is particularly the case with very long reports that are often an agglomeration of numerous perspectives, chapters, and topics.

Weave.AI also uses computer vision to automatically identify, rank and integrate key charts and infographics from long ESG and related reports—like how a self-driving car identifies pedestrians, bicycles, or traffic signs on the road. A Weave.AI smart talking point also automatically links to the relevant page in the relevant document from whence it came—this is critical so that the user can click on a talking point and navigate to the specific page for follow-up. This also is critical from an ESG and regulatory perspective as it enhances transparency and explain-ability. Users can also copy and paste smart talking points to the clipboard and embed them in standard publishing tools (Word, PowerPoint, Excel, Google Docs, Microsoft Outlook, Gmail, etc.) and optionally send them via email to clients, prospects, regulators, or colleagues. Weave.AI also analyzes news articles from authoritative sources to detect ESG-related risks, controversies, and positive developments.

Smart ESG talking points: Traditional ESG scoring algorithms are very susceptible to greenwashing because they can be fooled by companies that merely pay lip service to a particular ESG issue without doing anything meaningful. Weave.AI uses proprietary summarization algorithms to detect key takeaways (or smart talking points) and then employs deep learning to rank said key takeaways by materiality. To do this Weave.AI employs proprietary language models that know the difference between an intent and an accomplishment, and how material a particular accomplishment is, and it does all this in the context of the industry in question. Furthermore, smart talking points are completely transparent: clicking on a smart talking point takes the user to the specific document and page where said company made that disclosure. This enables the user to learn more about the specific issue—right from the source.

Semantic deduplication: Weave.AI intelligently deduplicates smart talking points. This is a non-trivial problem because not all duplicates (or possible typos) are created the same. For instance, many reports have seemingly redundant talking points that appear to be typos but where the subtle differences in the talking points are very material. Weave.AI infers and takes intentionality and materiality into account and intelligently (and safely) deduplicates talking points.

Weave.AI ESG Knowledge Graph: Weave.AI's ESG Knowledge Graph is a comprehensive database of ESG-related topics, issues, technologies, organizations, and relationships. It provides the intelligent discovery of ESG insights out of mountains of reports and authoritative news articles, automatically determines which ESG issues are most material in each industry or custom peer group, and facilitates intelligent ESG benchmarking, question-answering, and gap analysis. The ESG Knowledge Graph is automatically built using natural-language-processing—by analyzing millions of ESG data points daily. This solves the “I don't know what I don't know” problem which is very common within the ESG landscape—many companies and investors don't even know what to focus on or where to start. The ESG Knowledge Graph is updated 24/7 and its dynamic nature is critical because new ESG issues might pop up out of nowhere. For instance, no one could ever have predicted the Covid-19 pandemic and how companies' response to same could become an ESG topic. And no one could have predicted the chip shortage that is currently plaguing many industries, particularly the automotive industry. The Weave.AI ESG Knowledge Graph automatically unearths ESG-related issues as they occur—by detecting if an issue is ESG-related and if it is starting to appear repeatedly in material sources (ESG disclosures on a global basis, ESG webcasts run by sell-side analysts, or authoritative news sources).

ESG question-answering: By inferring and annotating disclosure data, authoritative news coverage, metadata (including precise publication dates, a non-trivial problem), and the ESG Knowledge Graph, Weave.AI enables extremely sophisticated ESG question-answering (by asset managers, ESG-conscious investors, or companies). For example: 1.) What is the most material accomplishment Hormel Foods has made in ESG in the last 5 years? 2.) Which company within the entertainment industry is making the most material accomplishments in either gender diversity, racial justice or human rights, and which ones have made the most strides in the past 12 months?

Smart ESG alerts: Weave.AI also supports smart ESG alerts—newly unearthed ESG risks, and smart ESG talking points in newly published disclosures that meet certain criteria.

Semantic harmonization and context: Weave.AI performs semantic harmonization for use in analytics (gap analysis) and benchmarking. Without harmonizing semantics and context benchmarks can often be wrong. To take an example companies can talk about ‘diversity’ in a myriad of different ways and without semantic harmonization benchmarks and downstream analytics will likely mislead. By using proprietary AI language models and deep learning Weave.AI also understands context—it not only knows the various ways the word ‘diversity’ can be expressed but also knows that the phrase “we added Suzanne and Mary to our board” indicates a material accomplishment from a gender diversity standpoint.

Semantic disambiguation and context: Weave.AI also understands the difference between words like ‘waste,’ ‘fine’ and ‘strike’ in an ESG context and said words in a generic context. Unlike a search engine a knowledge graph cannot ask the user “Did you mean this or that?” A knowledge graph must be right. In addition, a knowledge graph provides the basis for semantic inference and programmability which means that errors can multiply very quickly. This constitutes an extremely high bar that requires very different algorithms relative to traditional approaches.

Semantic inference: In addition to understanding context, Weave.AI performs intelligent semantic inference to annotate talking points with what we call ‘parent themes.’ For instance, the country Turkey is a child theme and ‘Emerging Markets’ is a parent theme. If a smart talking point refers to the noun ‘Turkey,’ this might be the country or the bird. Weave.AI's semantic disambiguation algorithms automatically infer that the talking point is referring to the country. However, to further infer that the talking point is referring to an emerging market, semantic inference is performed, and the algorithms compute additional scores as it traverses inferential hops. This is particularly critical with very broad parent themes like ESG.

Fully transparent ESG report cards: Weave.AI's ESG report cards are infographics that summarize a company's ESG performance relative to its peer group. Unlike traditional ESG report cards which are very sparse, Weave.AI's report cards are deeply integrated with the Weave.AI ESG Knowledge Graph and indicate precisely where a company is under-performing or over-performing relative to its peers. These topics, called themes, are generated by the knowledge graph. Unlike traditional report cards, Weave.AI's report cards are also fully interactive—the user can click on a particular peer to pivot from peer to peer, find out areas of underperformance or overperformance, then click on those areas to determine the smart talking points corresponding to said areas. The smart talking points can then be clicked to navigate the user to the specific document where the company made said disclosure, and the specific page therein. This provides an end-to-end and fully transparent experience of ESG benchmarking and analytics—as opposed to opaque black boxes that don't provide access to the underlying data.

Seamless peer discovery and analysis, and the global Weave.AI Knowledge Graph: ESG report cards also allow the user to browse companies that are peers of a company in the Weave. For instance, an ESG ETF Weave might have Disney as one of its holdings. The Weave would allow the user to view the Disney report card, view the other companies in Disney's peer group and drill-down into their ESG performance. Furthermore, the global Weave.AI Knowledge Graph connects every security with every fund and includes other relationships (such as ‘peers’), thereby allowing the user to navigate from an ESG ETF Weave to a company in that Weave to the peer of that company to the fund Weaves (e.g., other ETF Weaves or mutual fund Weaves) that that peer is included in. This global knowledge graph facilitates intelligent discovery, recommendations, and analytics.

Actionability: Because Weave.AI's gap analysis and report cards are fully transparent, companies and investors can get a clear roadmap into where to improve, and in what order. For instance, companies might already be making material strides but not disclosing them or might need to know what steps to take that will move the needle the most in terms of their ESG performance. Asset managers also benefit from this from a compliance, stewardship, and portfolio allocation standpoint.

Customizability: Weave.AI also allows customers to create benchmarks based on custom themes—such as Renewable Energy or a subset of ESG (e.g., the ‘E’, the ‘S’ or the ‘G’). This level of customization is very powerful as it enhances transparency. For instance, Tesla might be very strong in the E but weak in S or G and it is very difficult for investors to determine why. By allowing custom benchmarks investors can illuminate why Tesla might be under-performing from different perspectives. Customers can create custom benchmarks with a specific set of companies they wish to compare themselves against. For instance, some big-cap customers might want to compare themselves not only against their peers but against other big-caps in their region (e.g., the EU). Asset managers might also want to create custom benchmarks for certain companies that straddle multiple industries (e.g., benchmarking Tesla against either automotive peers or solar peers, or Amazon against either technology peers or retail peers). Weave.AI's scores and report cards can then be integrated into custom portfolio allocation models that align with the specific objectives of the fund in question or specific ideas by the fund manager(s).

Good house in a bad neighborhood: A common problem asset managers (and companies) run into is how to benchmark a company when the entire industry that company is in is poorly performing. Even if the entire industry performs poorly or has a history of greenwashing, Weave.AI can be used to ‘raise the bar’ by benchmarking the entire parent industry group or the sector, based on the GICS taxonomy or custom taxonomies. This will illuminate companies that are under-performing and/or greenwashing relative to a higher-performing peer group.

Time-scoped and custom-scoped ESG analysis: In addition to its broad-based benchmarks based on historical data, Weave.AI's ESG benchmarks can also be created to evaluate companies' performance within a specific time-period. Indeed, Weave.AI goes even further: custom benchmarks can also be created that combine multiple facets from the underlying dataset. For instance, an investor might want to benchmark companies only within a specific time-period and only based on investor-held webcasts that tend to be more independent of company spin.

Benchmarking small vs. large caps: Benchmarking small companies vs. large ones can often yield misleading results. Weave.AI includes sophisticated debiasing algorithms to ensure that larger companies do not end up with inflated gap analysis scores merely because they have more disclosure volumes or dramatically more news coverage. Weave.AI also considers the size of the company while determining how material a particular investment is.

Greenwashing detection and ESG risk and opportunity monitoring: Smart talking points are ranked based on materiality and Weave.AI distinguishes empty rhetoric from material accomplishments. In addition to analyzing corporate disclosures Weave.AI includes ESG webcast transcripts based on ESG-specific calls with Wall Street analysts. The themes are ranked not only by what the companies disclose but also on the questions ESG analysts are posing to the companies. Indeed, this analyst-provided insights are ranked as being more authoritative by Weave.AI's materiality algorithms. Weave.AI also analyzes news and videos (updated in real-time) from the world's top sources to detect material ESG risks and positive developments at a company and at an industry level. These attributes—weighted by the authoritativeness of the source—are also factored into a company's performance rating. Weave.AI also uses these news articles and videos as inputs into its ESG Knowledge Graph—if, over time, the algorithm notices a significant issue in the news, it automatically adds that issue to the knowledge graph and updates the scores of the affected companies. And if our AI detects an ongoing discrepancy between a company's public disclosures and a pattern of controversies as reported in authoritative news sources (we call this ‘disclosure drift’), this will negatively impact its score. Lastly, customers can leverage these flagged risks or positive developments in time-series models that predict changes to a company's ESG score.

ESG related client engagement: Weave.AI uniquely employs advanced AI to analyze ESG ETFs and other funds, in addition to ESG-related client proposals, presentations, and entire portfolios, and distill out only the most relevant facts, graphics, and trends—called smart talking points—to help more rapidly build personalized, compelling ESG stories for each client, advisor or stakeholder. This turbocharges client acquisition, engagement and retention and drives AUM growth. These stories—called ‘Weaves’—are snackable, digestible, interactive, and measurable, a format optimized for digital engagement, personalization and retention.

1. At lightning speed, asset managers can now benchmark securities and evaluate the materiality of ESG claims in a manner that is transparent, explainable, and fully customizable. They can more readily engage with clients, regulators, internal teams, and companies, while increasing compliance. Weave.AI automatically transforms long arcane reports—ESG reports, ESG webcasts, earnings call transcripts, annual reports, press releases, regulatory filings, etc.—into smart talking points, intelligently ranked by materiality, to help investors improve ESG portfolio allocation and better engage clients, stakeholders, and regulators.

2. Weave.AI's ESG Knowledge Graph automatically identifies and ranks which ESG issues are most material in a given industry, classifies smart talking points into said ESG ‘themes,’ and automates ESG question-answering. Gap analysis helps investors identify specifically where companies are under-performing relative to a variety of peer groups. Weave.AI also monitors and flags ESG-related risks from global news and alternative sources and helps inoculate investors from greenwashing by reconciling company claims (or silence) with independent reports on material risks by authoritative news sources. Weave.AI detects if there are ongoing, persistent ESG risks (or positive developments) involving a specific company and builds time-series models out of said news reports. These models can be used for predictive analytics to forecast changes in a company's ESG score.

3. Companies can also use Weave.AI to automate the ESG benchmarking process—to understand precisely where they need to improve.

4. Weave.AI also helps asset managers turbocharge client and stakeholder engagement, thereby boosting AUMs while lowering investment and regulatory risk. We are in the middle of a $68T transfer of wealth. Young investors are not only digitally-savvy but a whopping 72% of them want to know whether a company lives up to their values before they invest. As a result, asset managers must fundamentally change how they engage with ESG-conscious investors. However, asset managers oftentimes continue to bombard prospects, existing clients, advisors, internal sales teams, and other stakeholders (including regulators) with long, arcane reports that no one can ever have time to read. This results not only in client and stakeholder frustration but also that vast amounts of organizational knowledge—typically created or purchased at great cost—are never leveraged to better engage or retain clients.

5. Besides, many ESG investors might be particularly interested in specific ESG concerns like sustainability, human rights, or gender equality. Yet triangulating these issues with oceans of fund reports is an impossible task. With ever-present concerns about greenwashing this lack of transparency frustrates investors and can lead to client mistrust and disengagement, in turn hampering AUM growth.

6. Weave.AI employs advanced AI to analyze ESG ETFs and other funds, in addition to client proposals, presentations, and entire portfolios, and distill out only the most relevant facts, graphics, and trends—called smart talking points—to help more rapidly build personalized, compelling ESG stories for each client, advisor or stakeholder. This turbocharges client acquisition, engagement and retention and drives AUM growth. These stories—called ‘Weaves’—are snackable, digestible, interactive, and measurable, a format optimized for digital engagement, personalization and retention.

7. Weave.AI allows investors to dive deep into long, arcane reports on an ESG fund and its holdings. It also categorizes smart talking points based on context—allowing investors to view and personalize ESG-related talking points on the fund and the securities therein, intelligently ranked by materiality. Investors can specify which ESG ‘themes’ or ‘subthemes’—within E, S or G (not just E)—matter most to them. This is critical in earning investor trust, deepening client engagement and growing AUMs.

8. This entire invention can also be applied in other business, government, and consumer contexts—to benchmark and analyze large amounts of unstructured data from a variety of perspectives without having to manually read and analyze long reports—and is not just for asset managers or investors.

### 5. Visual Storytelling.

Weave provides an automated, AI-based publishing and storytelling platform to help businesses deliver extremely rich, personalized and measurable content experiences to attract, engage, retain and understand customers. Weave employs natural-language-processing, machine learning, and AI-based content augmentation to automatically transform static enterprise documents (white-papers, brochures, market research reports, sales documents, press releases, job descriptions, product specifications, financial reports, earnings call transcripts, etc.) to dynamic, interactive, mixed-media information hubs—in the process increasing user engagement by up to 55×. Weave also aligns the delivery of content with how today's consumers prefer to consume content: Visual, Interactive, Mobile, Personalized and Snackable (via bite-sized content pieces). And by providing deep analytics on precisely what drives user engagement Weave helps businesses not only gain a deeper understanding of their customers but also helps improve content planning, micro-targeting, audience segmentation, lead generation, user personalization and demand alignment, thereby deepening customer relationships while also reducing content-related marketing costs.

1.) For enterprise marketers there is a content engagement crisis: a.) 99.5% of enterprise documents and outbound messages get zero engagement and 95% are never even read. This has a direct impact on costs—it costs significant amounts of money to produce all this content, poor engagement hurts the brand, and the resulting information loss impedes the ability to acquire, engage and retain customers. Weave solves this problem by automatically transforming textual content into visual, dynamic mixed-media information hubs—with increases in user engagement of up to 55× b.) The sheer volume of information growth means this problem is only going to get worse (over 500B enterprise documents were created last year alone according to Microsoft)—it is becoming harder than ever to cut through the noise, c.) Static textual documents are not measurable in terms of what precisely drives engagement. Was it something on page 2 or the third paragraph of page 3 of a whitepaper that drove engagement? There is absolutely no feedback loop at the intra-content level. As a result, enterprises are flying blind and have close to zero insights into actual information consumption behavior of their customers. This stymies their ability to understand their customers and to provide them with targeted personalized messages that align with their interests. Weave solves this problem.

2.) For end users, a.) the search paradigm is running out of gas. Search requires that users know what to search for. The sheer amount of information growth severely limits information discovery. Weave automatically brings information to the user—at the right time and in the right context thereby dramatically increasing user productivity.

b.) users are much more visual and static textual documents are misaligned with today's information consumption trends: Visual, Interactive, Mobile, Personalized and Snackable (via bite-sized content pieces). Weave automatically transforms static documents into rich media storyboards and then visualizes and presents the storyboards with contextual cues, linked content, relevant video, etc.—in a highly visual, mobile aware, context-aware manner. This then drives user engagement.

c.) Weave automatically extracts context and then uses said context to automatically personalize the user experience. This then boosts user engagement and keeps users coming back.

Weave solves many shortcomings of prior information media:

1.) The automated transformation (leveraging natural language processing and machine learning) of static enterprise documents (white-papers, brochures, market research reports, sales documents, press releases, job descriptions, product specifications, financial reports, earnings call transcripts, etc.) to dynamic, interactive, mixed-media information hubs—in the process increasing user engagement by up to 55×.

2.) The automated visualization of the resulting dynamic storyboard in a manner that aligns the delivery of content with how today's consumers prefer to consume content: Visual, Interactive, Mobile, Personalized and Snackable (via bite-sized content pieces).

3.) Automated context extraction (leveraging natural language processing, semantic contextual analysis, entity extraction and semantic disambiguation) resulting in the ability to measure engagement with unprecedented specificity. By providing deep analytics on precisely what drives user engagement Weave helps businesses not only gain a deeper understanding of their customers but also helps improve content planning, micro-targeting, audience segmentation, lead generation, user personalization and demand alignment, thereby deepening customer relationships while also reducing content-related marketing costs.

4.) The automatic linking of related content (leveraging automated context extraction) thereby driving content discoverability.

Weave is a brand-new information publishing medium—marrying AI, visual storytelling and the cloud. Weave has a complete publishing stack—
1.) the automated processing of static unstructured data (the inputs), the automated extraction of context, semantic analysis, semantic disambiguation
2.) the automated generation of a “script” which forms the basis of a semantic index of the unstructured document inputs
3.) The processing of the script to automatically gather relevant content from around the Web—videos, related media, social media, etc.
4.) Automated content scoring using machine learning—to ensure that only content from authoritative sources (and based on real-time user engagement feedback) is included in the final storyboard
4.) The generation of a “manifest” which is independent of any particular rendering device
5.) The dynamic rendering of the manifest to various devices—the Web, mobile, the AppleWatch, voice interfaces like Alexa, Google Home and Apple HomePod, and virtual/augmented reality. Rendering is done visually, contextually, dynamically and automatically. Relevant contextual information is also displayed all in one place, obviating the need for users to keep searching for related information. User engagement is unprecedented with some Weaves (the resultant storyboards) getting up to 2 hours of user engagement.
5.) The real-time analysis of a user's interaction with the storyboard and the real-time personalization of rendered content based on the user's interaction behavior
6.) The gathering of aggregate context-specific user-interaction behavior, leveraging aforementioned extraction of relevant context. This in turn helps customers understand what precisely drives user engagement so they can better align their content with user interests and needs.

Weave's features include:
1.) Intelligent content augmentation-transforming static enterprise documents into rich, visual, dynamic, interactive mixed-media information hubs (resulting in up to a 55× increase in user engagement)
2.) Intelligent context extraction using natural language processing, semantic analysis and semantic disambiguation
3.) Visual and contextual storytelling
4.) Intelligently rendering of transformed content on a variety of devices that employ different interaction models (including voice interfaces and virtual/augmented reality platforms)
5.) The automatic linking the transformed content into an intelligent contextual network.
6.) Intelligent and context-aware user personalization of delivered content
7.) Intelligent, contextual analytics—the ability to accurately and specifically measure user interaction behavior based on intelligent context and use said analytics for intelligent content planning, demand alignment and personalization.

1.) The automated transformation (leveraging natural language processing and machine learning) of static enterprise documents (white-papers, brochures, market research reports, sales documents, press releases, job descriptions, product specifications, financial reports, earnings call transcripts, etc.) to dynamic, interactive, mixed-media information hubs—in the process increasing user engagement by up to 55×.

2.) The automated visualization of the resulting dynamic storyboard in a manner that aligns the delivery of content with how today's consumers prefer to consume content: Visual, Interactive, Mobile, Personalized and Snackable (via bite-sized content pieces).

3.) Automated context extraction (leveraging natural language processing, semantic contextual analysis, entity extraction and semantic disambiguation) resulting in the ability to measure engagement with unprecedented specificity. By providing deep analytics on precisely what drives user engagement Weave helps businesses not only gain a deeper understanding of their customers but also helps improve content planning, micro-targeting, audience segmentation, lead generation, user personalization and demand alignment, thereby deepening customer relationships while also reducing content-related marketing costs.

4.) The automatic linking of related content (leveraging automated context extraction) thereby driving content discoverability.

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A computer-implemented method, comprising the steps of:
generating to a display device a graphical user interface (GUI), the display device coupled to at least one processing device;
generating within the GUI a file-icon reception field;
receiving from a user a command to move into the reception field an icon representing a digital file containing a data set;
accessing the digital file;
generating a table of contents characterizing the data set; and
displaying in the GUI one or more portions of the data set based on the table of contents.

2. The method of claim 1, wherein the user command comprises the user dragging and dropping the icon within the field.

3. The method of claim 1, further comprising formatting the displayed one or more portions of the data set as one or more sharable links.

4. At least one computer-readable medium on which are stored instructions that, when executed by one or more processing devices, enable the one or more processing devices to perform a method, the method comprising the steps of:
generating to a display device a graphical user interface (GUI), the display device coupled to at least one processing device;
generating within the GUI a file-icon reception field;
receiving from a user a command to move into the reception field an icon representing a digital file containing a data set;
accessing the digital file;
generating a table of contents characterizing the data set; and
displaying in the GUI one or more portions of the data set based on the table of contents.

5. The medium of claim 4, wherein the user command comprises the user dragging and dropping the icon within the field.

6. The medium of claim 1, wherein the method further comprises formatting the displayed one or more portions of the data set as one or more sharable links.
